(19) United States
(12) Patent Application Publication
(10) Pub. No.: US 2024/0003625 A1
(43) Pub. Date: Jan. 4, 2024

(54) APPARATUS AND METHOD FOR COLLECTING DRIED PHARMACEUTICAL PRODUCT FROM A PHARMACEUTICAL DRYING DEVICE

(71) Applicant: MERCK SHARP & DOHME LLC, RAHWAY, NJ (US)

(72) Inventors: John H. Roosa, Hillsborough, NJ (US); Frank D. Gianotti, III, Bound Brook, NJ (US); Robert C. O'Connor, Aberdeen, NJ (US); Luke Ryan Schenck, Yardley, PA (US); Matthew Yuhas, Jr., Martinsville, NJ (US)

(73) Assignee: MERCK SHARP & DOHME LLC, RAHWAY, NJ (US)

(21) Appl. No.: 18/255,021

(22) PCT Filed: Dec. 2, 2021
(86) PCT No.: PCT/US2021/061542

§ 371 Date: May 30, 2023

Related U.S. Application Data
(60) Provisional application No. 63/124,419, filed on Dec. 11, 2020.

(51) Int. Cl. F26B 25/00; F26B 5/04

(52) U.S. Cl. CPC F26B 25/002; F26B 5/04

(57) ABSTRACT

Apparatus and method for collecting a dried pharmaceutical product from a product reservoir of a pharmaceutical drying device, such as a thin film evaporator, while the product reservoir remains under continuous vacuum pressure. The apparatus comprises a discharge chute, a vacuum supply control valve, a product inlet valve, a gas control valve, a collection control valve and one or more collection containers The discharge chute comprises a substantially airtight internal chamber, a housing substantially surrounding the airtight internal chamber, a vacuum supply inlet that fluidly connects the airtight internal chamber of the discharge chute to a vacuum source, a solids inlet that fluidly connects the internal chamber to a product reservoir of the dryer, a gas inlet that fluidly connects the airtight internal chamber to a gas source, and a solids outlet that fluidly connects the airtight internal chamber to a collection container The inlets and outlets are opened and closed by operation of flow control valves connected to those inlets and outlets in order to remove or admit gas to the discharge chute to effectively depressurize and re-pressurize the discharge chute, while moving dried pharmaceutical product out of the dryer and through the discharge chute. A flow diverter assembly directs “on-spec” material to a primary collection container and “off-spec” material to an auxiliary or “waste” collection container.

### FIELD OF THE INVENTION

The present invention relates to systems, methods and apparatus for removing solids, such as dried powder forms of pharmaceutical products, including active pharmaceutical ingredients (“APIs”), drug products and drug product intermediates, from a drying device, such as a thin film evaporator, in a drug manufacturing production line.

### BACKGROUND OF THE INVENTION

For industrial scale manufacturing and packaging of pharmaceuticals, it is sometimes necessary or desirable to first prepare liquid mixtures or slurries of an API, a drug product (comprising an API plus excipients) or drug product intermediate, and then put the liquid mixtures or slurries through a heating, drying and/or evaporation step to remove all (or most) of the liquid. This process can produce a dried powder form of the API, drug product or drug product intermediate containing micronized or nano-sized particles of the API. The dried powder form of the API, drug product or drug product intermediate tends to have increased chemical and physical stability, as well as a higher capacity for oral administration via conventional tablets and capsules. The heating, drying and/or evaporating step often requires feeding the liquid mixture or slurry into a drying space of a drying device, such as the evaporator of a thin film evaporator, and raising the temperature in the drying space by a sufficient amount so that the more volatile liquid components of the liquid mixtures and slurries will be boiled away, distilled off or otherwise separated from the solid particles, and then removed from the drying space as a vapor, thereby leaving in the drying space only the desired dried powder form of the pharmaceutical product containing the API. However, it is not always necessary to use heat (or a heat source) to separate the liquid components from the solid particles. Depending on the vapor pressures of the solvents used, reducing the vacuum pressure in the drying space (without raising the temperature) may be sufficient to achieve separating and removing the liquid components as a vapor from the drying space.

In most cases, the drying space of the drying device is substantially enclosed and operated under vacuum conditions (i.e., at air pressures less than standard atmospheric pressure) to keep the boiling points for the liquids as low as possible. Keeping the boiling points low typically minimizes degradation of the APIs, drug products, drug product intermediates or drug substances being processed. It also may save (1) a significant amount of time in the drying step, (2) a considerable amount of energy otherwise required to heat the drying space to meet higher boiling points, and (3) a substantial amount of wear and tear on the heating equipment that would otherwise have to be capable of withstanding extreme vacuum conditions and/or significantly higher amounts of heat.

However, on an industrial scale, there are some significant drawbacks associated with producing and packaging pharmaceuticals using a process that includes drying liquid mixtures under vacuum-pressured conditions. For one thing, it is often very difficult or impossible to remove the dried pharmaceutical product from the vacuum-pressured container of the dryer (so that the dried pharmaceutical product can be moved on to the next step in the manufacturing or packaging process) without breaking the vacuum-pressured atmosphere (i.e., the vacuum) that must exist in the dryer to achieve the best and most efficient separation of the liquid and dried components. Thus, whenever a sufficient amount of the pharmaceutical product is dried to form a powder and is ready to be removed from the dryer, the operation of the dryer must be temporarily halted and the vacuum-pressured container in the dryer must be temporarily depressurized (i.e., brought up to atmospheric pressure level) so that the accumulated dried powder form of the pharmaceutical product can be safely collected from the dryer.

Typically, halting or pausing the drying operation also requires halting or pausing some or all of the upstream and downstream operations connected to the drying operation, such as the operation of feeding the liquid mixtures or slurries into the dryer, the operations of bagging and packaging the dried powder form of the API, drug product or drug product intermediate that come after the drying step, and potentially stopping or pausing several other steps or operations on the pharmaceutical product production line. This slows down the entire production process. Worse yet, repeatedly pausing and restarting the pharmaceutical product production line to accommodate the safe removal of dried pharmaceutical products from the dryer normally means the pharmaceutical product can only be produced in batches, instead of being produced continuously. Batch processing almost always results in the drug manufacturer losing a considerable amount of opportunity, time and money (when compared to continuous production), and often exposes the pharmaceutical products and the operators on the production line to increased risk of contamination associated with removing the pharmaceutical product from the production line in discrete batches.

Unlike manufacturing and packaging drugs in batches, continuous drug manufacturing and packaging permits an entire lot of the pharmaceutical product to be produced without pausing or stopping the production line to remove discrete batches of finished product from the line. As such, continuous production and packaging pharmaceutical products in dried powder form offers many benefits, including, for example, lower cost, more nimble control over production rates in response to market demand, shorter production times, more consistent outputs, and potentially increased product quality assurance through more rigorous testing and monitoring. Because of these and other advantages, continuous manufacturing and packaging of pharmaceutical products is increasingly considered to be an important objective, if not an absolutely necessary requirement, in the pharmaceutical manufacturing industry.

Companies that manufacture pharmaceutical products in dried powder form on an industrial scale, whether by batch processing or by continuous processing, must be extremely vigilant to guard against, reduce or eliminate any risk of potential contamination of the pharmaceutical products, potential contamination of the surrounding environment, and potential contamination of the human operators and staff persons, especially when the drug products, drug product intermediates or drug substances being manufactured or processed are considered harmful or toxic to humans. In order to reduce and avoid these risks, manufacturing dried powder form pharmaceuticals on an industrial scale often includes performing certain operations or steps in a cleanroom environment, and also may require the operator to use personal protective equipment (PPE), such as breathing apparatus and protective clothing, such as gloves or coveralls, to prevent excessive human exposure to the drugs, drug by-products, solvents, anti-solvents and excipients. The cleanrooms often need to qualify as a “Grade C-classified” space.

Traditional Grade C-classified spaces can be extremely expensive (typically costing millions of dollars) to build, maintain and operate, and they can occupy an enormous footprint in a manufacturing facility, in terms of the physical space required. As competition from generic products intensifies, the cost of real estate continues to appreciate, and calls for pharmaceutical price controls grow, it is becoming considerably more advantageous for companies in the pharmaceutical industry to develop and use containment systems and processes that provide the same or better safety conditions as traditional cleanrooms while occupying smaller footprints than traditional cleanrooms, and implement containment systems and processes that cost less money and time than traditional cleanrooms to operate and maintain.

### BRIEF SUMMARY OF EXEMPLARY EMBODIMENTS

Embodiments of the present invention provide a contained apparatus and method for collecting pharmaceutical products, such as dried solids, from a drying device, such as a thin film evaporator, in a drug manufacturing production line without breaking the vacuum-pressured conditions existing in the drying device. The apparatus and method therefore enable and facilitate continuous operation of the drying device and continuous processing and packaging of the dried pharmaceutical products upstream and downstream of the drying device. More specifically, the apparatus and method of the present invention facilitates maintaining vacuum pressure in the drying unit of the process train, while permitting other components in the process train, outside of the drying unit, to be temporarily pressurized. Having the ability to temporarily remove and restore vacuum pressure inside selective components of the process train, without breaking the vacuum condition in the drying unit, is beneficial because it permits collection and removal of dried powder product from the production line without halting the operation of the drying unit. Advantageously, the system allows for reinstatement of the vacuum conditions in all the critical components, as desired, after a desired quantity of dried powder has been collected and moved into collection containers. These embodiments also enable manufacturing, processing and handling of the dried powder pharmaceutical products in a safely contained environment that occupies a smaller footprint than a conventional cleanroom, and requires less money and time than conventional cleanrooms to build, maintain and operate.

In one embodiment, the present invention provides an apparatus for collecting a pharmaceutical product from a product reservoir of a pharmaceutical drying device (i.e., a dryer) while the product reservoir remains under continuous vacuum pressure. The apparatus comprises a discharge chute, a vacuum supply control valve, a product inlet valve, a gas control valve and a collection control valve. The discharge chute comprises a substantially airtight internal chamber, a housing substantially surrounding the airtight internal chamber, a vacuum supply inlet that fluidly connects the airtight internal chamber of the discharge chute to a vacuum source, a solids inlet that fluidly connects the airtight internal chamber to a product reservoir of the dryer, a gas inlet that fluidly connects the airtight internal chamber to a gas source, and a solids outlet that fluidly connects the airtight internal chamber to a collection container. The inlets and outlets may be opened and closed by operation of the control valves, which are connected to those inlets and outlets in order to remove or admit gas to the discharge chute to effectively depressurize and re-pressurize the discharge chute, while moving dried pharmaceutical product out of the dryer and through the discharge chute. The control valves may be operated manually, or alternatively, activated automatically by a computer system programmed to generate and transmit electronic control signals to devices that produce mechanical forces to actuate the valves in response to electric current.

The steps of depressurizing and re-pressurizing of the discharge chute and the moving of the dried pharmaceutical product through the discharge chute is carried out in a time-coordinated manner so that the vacuum-pressured condition of the dryer is not interrupted or broken . In certain embodiments, the discharge chute further comprises a flow diverter assembly configured to give the operator the option of diverting some portion of the dried powder flowing out of the discharge chute into a second (or auxiliary) collection container.

In some embodiments, the apparatus of the present invention also includes a flexible isolator, attached to the discharge chute, which is configured to surround and enclose the fluid connection between the product outlet on the discharge chute and the primary collection container, and thereby substantially isolate the fluid connection between the product outlet and the primary collection container from a surrounding environment.

In another implementation of the present invention, there is provided an airlock assembly for collecting solids from a product reservoir of a drying device while the product reservoir remains under continuous vacuum pressure. In general, the airlock assembly comprises a discharge chute, a vacuum supply control valve, a product inlet valve, a gas control valve and a collection control valve:

In still another implementation of the present invention, there is provided an automated collection system for collecting a dried pharmaceutical product from a product reservoir of a dryer while the product reservoir of the dryer is under continuous vacuum pressure. In general, the automated collection system comprises a computer system, at least one input/output block, a discharge chute, a primary collection container and an isolator. Typically, the discharge chute comprises a plurality of sanitary spool tubes connected in series to form a substantially continuous passageway extending from one end of the discharge chute to the opposite end of the discharge chute. Preferably, at least some of the sanitary spool tubes comprising the discharge chute have built-in instrumentation ports for connecting sensor instruments for taking various measurements, such as, for example, pressure sensors, temperature sensors, contact and non-contact infrared (IR) and Fourier Transform infrared (FTIR) Ramen spectrometry sensors, and product height or level-sensors.

In yet another implementation, certain embodiments of the present invention provide a method of using a discharge chute to collect a pharmaceutical product from a product reservoir of a dryer while the product reservoir of the dryer is under continuous vacuum pressure. The method comprises the steps of:

a) detecting with a pressure gauge a measured pressure level inside the internal chamber of the discharge chute;

b) opening the vacuum supply inlet valve of the discharge chute;

c) activating the vacuum source to remove gases from the internal chamber via the vacuum supply inlet valve until the pressure gauge detects that the pressure inside the internal chamber of the discharge chute is less than or equal to the continuous vacuum pressure existing inside the product reservoir of the dryer;

d) opening the product inlet valve on the discharge chute while the pressure gauge indicates that the measured pressure level inside the internal chamber of the discharge chute is less than or equal to the continuous vacuum pressure existing inside the product reservoir of the dryer;

e) causing at least a portion of the pharmaceutical product inside the product reservoir to flow through the product inlet and into the internal chamber of the discharge chute;

f) closing the product inlet valve on the discharge chute;

g) opening the gas inlet valve of the discharge chute;

h) activating the gas source to force gas into the internal chamber of the discharge chute via the gas inlet valve until the pressure gauge indicates that the pressure inside the internal chamber of the discharge chute has reached an ambient pressure level;

i) opening the product outlet valve while the pressure gauge indicates that pressure inside the internal chamber of the discharge chute is at the ambient pressure level; and

j) causing at least some of the pharmaceutical product located inside the internal chamber of the discharge chute to flow out of the internal chamber, through the product outlet valve and into the primary collection container.

### BRIEF DESCRIPTION OF THE FIGURES

The accompanying drawings, which are incorporated into and constitute part of the specification, illustrate preferred embodiments of the invention, and, together with the description, serve to explain the principles of the present invention.

FIG. 1 shows a front-side perspective view of one example of a pharmaceutical product collection apparatus according to one embodiment of the present invention.

FIG. 2 shows a left-side perspective view of the exemplary pharmaceutical product collection apparatus shown in FIG. 1.

FIG. 3 shows a more detailed perspective view of the product inlet and product inlet control valve components of the exemplary pharmaceutical product collection apparatus shown in FIG. 1, in which the product inlet control valve is turned to the open position.

FIG. 4 shows a more detailed perspective view of the product inlet, product inlet control valve and sight glass assembly components of the exemplary pharmaceutical product collection apparatus shown in FIG. 1, wherein the product inlet control valve is turned to the closed position.

FIG. 5 shows a more detailed perspective view of the vacuum supply inlet, vacuum supply control valve, gas inlet and gas control valve components of the exemplary pharmaceutical product collection apparatus shown in FIG. 1, wherein the vacuum control valve is open and the gas control valve is closed.

FIG. 6 shows a more detailed perspective view of the vacuum supply inlet, vacuum supply control valve, gas inlet and gas control valve components of the exemplary pharmaceutical product collection apparatus shown in FIG. 1, wherein the vacuum control valve is closed and the gas control valve is open.

FIG. 7 shows a perspective left-side view of the flow diverter assembly and an exemplary coupling system for attaching the flexible isolator to the flow diverter assembly in the exemplary pharmaceutical collection apparatus shown in FIG. 1, wherein the coupling system comprises a single mounting plate, a groove around the perimeter of the single mounting plate and an elastic band arranged to hold the built-in O-ring of the flexible isolator inside the groove.

FIG. 8 shows a perspective front-side view of the flow diverter assembly and exemplary coupling system shown in FIG. 7, as well as a close-up view of the mounting ring clamp fastened to the perimeter of the mounting ring of the coupling system.

FIG. 9 shows a perspective left-side view of the primary and auxiliary exit channels of the flow diverter assembly, the product outlet and the collection control valves, as well as the left side of a flexible isolator arranged in accordance with an exemplary embodiment of the pharmaceutical product collection apparatus of the present invention.

FIG. 10 shows a discharge port, attached to the flexible isolator, to facilitate removing primary and/or auxiliary collection containers filled with pharmaceutical product from the inside of the flexible isolator.

FIG. 11 shows a high-level computer aided drawing (CAD) illustrating by way of example a perspective view of some of the main components of a pharmaceutical product collection apparatus according to one embodiment of the present invention.

FIG. 12 shows a high-level computer aided drawing (CAD) illustrating a cross-sectioned view of the exemplary pharmaceutical collection apparatus shown in FIG. 11.

FIG. 13A shows a high-level computer aided drawing (CAD) illustrating a left side view of the exemplary pharmaceutical collection apparatus shown in FIG. 11.

FIG. 13B shows a high-level computer aided drawing (CAD) illustrating a cross-sectioned view along a cut-line E-E of the exemplary pharmaceutical product collection apparatus shown in FIG. 13A.

FIG. 14A shows a high-level computer aided drawing (CAD) illustrating a right side view of the exemplary pharmaceutical collection apparatus shown in FIG. 11.

FIG. 14B shows a high-level computer aided drawing (CAD) illustrating a cross-sectioned view along a cut-line F-F of the exemplary pharmaceutical product collection apparatus shown in FIG. 14A.

FIG. 14C shows a high-level computer aided drawing (CAD) illustrating a cross-sectioned view along the cut-line G of the exemplary pharmaceutical product collection apparatus shown in FIG. 14B.

FIG. 15 shows a high-level computer aided drawing (CAD) illustrating an isometric view of the flexible isolator and built-in O-ring component of the exemplary pharmaceutical collection apparatus shown in FIG. 11.

FIG. 16 shows a high-level computer aided drawing (CAD) illustrating an isometric view of an alternative coupling system for attaching the flexible isolator of FIG. 15 to the flow diverter assembly in the exemplary pharmaceutical collection apparatus shown in FIG. 11, wherein the coupling system comprises two separate mounting plates, instead of a single mounting plate, and the O-ring of the flexible isolator shown in FIG. 15 is sandwiched between the two mounting plates.

FIG. 17A shows a high-level computer aided drawing (CAD) illustrating a left side view of the alternative coupling system shown in FIG. 16.

FIG. 17B shows a high-level computer aided drawing (CAD) illustrating a cross-sectioned view along a cut-line M-M of the alternative coupling system shown in FIG. 17A.

FIG. 18 shows a high-level flow diagram illustrating the steps that could be used to carry out a method of collecting dried solids from a drying device using a pharmaceutical product collection apparatus constructed in accordance with one embodiment of the present invention.

FIG. 19 shows a high-level schematic diagram of an automated collection system for collecting solids from a drying device according to an embodiment of the present invention.

FIGS. 20 shows a high-level block diagram illustrating by way of example the architecture of a computer system configured to generate and transmit electrical signals to an input/output board, which is configured to activate solenoid coils in solenoid valves to open and close the solenoid valves according to an embodiment of the present invention.

FIGS. 21 and 22 show a high-level flow diagram depicting by way of example the steps of an algorithm that could be performed by the computer system configured to operate according to an embodiment of the automated collection system to generate and transmit control signals to activate, open and close solenoid valves in a solids collection system.

### DETAILED DESCRIPTION OF EXEMPLARY EMBODIMENTS

Examples of embodiments of the present invention will now be described in some detail. Notably, the exemplary embodiments described below and shown in the drawings are not meant to limit the scope of the present invention or its embodiments or equivalents.

In one embodiment, the present invention provides an apparatus for collecting a pharmaceutical product from a product reservoir of a pharmaceutical drying device (i.e., a dryer) while the product reservoir remains under continuous vacuum pressure. In this embodiment, the apparatus comprises a discharge chute, a vacuum supply control valve, a product inlet valve, a gas control valve and a collection control valve. The discharge chute is fluidly connected to the dryer, and more specifically, fluidly connected to the product reservoir in the dryer. The dryer may comprise any one of a variety of different devices commonly used to separate the dry components of a liquid mixture or slurry from wet components of said liquid mixture or slurry, including without limitation, a thin-film evaporator, an agitated thin-film evaporator, a wiped film evaporator, a rotary dryer, a spray dryer, a conical dryer, a pressure filter, a fluid bed, or a combination of two or more thereof. The discharge chute has a housing (i.e., an outer shell or jacket formed by one or more outer walls) that defines a substantially hollow internal chamber (or void) inside the discharge chute. The housing is configured to receive and hold dried, or partially dried, powder discharged from a product reservoir inside the dryer after some amount of excess liquid and/or moisture has evaporated or otherwise separated from the liquid mixture or slurry put into the dryer. It is not critical that all of the liquid or moisture has been evaporated or separated from the solid particles in the liquid mixture or slurry put into the dryer.

In this context, the term “product reservoir” means any area, space, tank, tube or compartment inside the dryer where solids or other concentrates are collected and held for discharge after the excess liquid and/or moisture is removed from the liquid mixture or slurry by operation of the dryer. For example, in some cases, the product reservoir may comprise an evaporator tank inside a thin film evaporator, a discharge nozzle connected to the evaporator tank, or both, because these are the locations in the thin film evaporator where the dried powder or concentrate is collected or accumulates after the liquid mixture or slurry is dried to remove the excess liquid or moisture. The pharmaceutical product collected in the product reservoir of the dryer may comprise an active pharmaceutical ingredient, a drug product intermediate or a drug product. The pharmaceutical product may exist in a variety of different forms, including without limitation, an active pharmaceutical ingredient produced by drying or partially drying a liquid mixture or slurry containing the active pharmaceutical ingredient, a pharmaceutical composition containing such an active pharmaceutical ingredient, a dry powder, a partially dry powder, a solid, a solid-solid mixture, or a combination of two or more thereof. The pharmaceutical product also may exist as a suspension, a viscous liquid, a slurry, a solid-liquid mixture, or a combination of two or more thereof.

The discharge chute has several inlets and outlets configured to permit dried pharmaceutical products and gases to pass into and out of the internal chamber. These inlets and outlets typically include (1) a product inlet that fluidly connects the internal chamber of the discharge chute to the product reservoir of the dryer, (2) a vacuum supply inlet that fluidly connects the internal chamber of the discharge chute to a vacuum source, (3) a gas inlet that fluidly connects the internal chamber of the discharge chute to a gas source, and (4) a product outlet that fluidly connects the internal chamber of the discharge chute to a primary collection container that may be removably connected to the product outlet of discharge chute to “catch” and/or bundle the dried pharmaceutical product solids into a package.

Suitably, the inlets and outlets on the discharge chute may be opened and closed by operation of the aforementioned valves, which are connected to those inlets and outlets. For example, the vacuum supply control valve is connected to the vacuum supply inlet of the discharge chute and it may be operated (by manual and/or automated means) to open the vacuum supply inlet on the discharge chute to start a suctioning of gases from the internal chamber of the discharge chute through the vacuum supply inlet by operation of a vacuum source connected to the vacuum supply inlet opposite from where the vacuum supply inlet is fluidly connected to the internal chamber of the discharge chute. Because the internal chamber is substantially airtight when all of the other inlets and outlets are closed off by the other valves, removing gases from the internal chamber via the vacuum supply inlet by the vacuum supply source decreases the air pressure inside the internal chamber, which creates a vacuum condition (negative air pressure) inside the internal chamber. Preferably, a sufficient amount of gas is removed from the internal chamber so that the pressure level inside the internal chamber is reduced until it is less than or substantially equal to the pressure level of the vacuum condition existing inside the product reservoir of the dryer. When the desired vacuum condition is achieved inside the internal chamber, the vacuum supply control valve may be operated (by manual or automated means) to close the vacuum supply inlet.

When the pressure level inside the internal chamber of the discharge chute is less than or substantially equal to the vacuum condition existing in the product reservoir of the dryer, the vacuum supply control valve is closed to shut down the vacuum supply inlet and the product inlet valve is opened to open the product inlet fluidly connecting the product reservoir of the dryer to the internal chamber of the discharge chute. Opening the product inlet permits some or all of the dried powder collected inside the product reservoir of the dryer during the drying process to flow (typically due to gravity) out of the product reservoir and into the internal chamber of the discharge chute through the product inlet. Advantageously, the product inlet can be opened, and the pharmaceutical product can be moved from the product reservoir of the dryer to the discharge chute, without breaking the vacuum condition (negative air pressure level) existing inside the product reservoir. This means that the operation of the dryer does not have to be suspended while the product inlet connecting the product reservoir of the dryer to the discharge chute is open.

When a sufficient, maximum or specified amount of the pharmaceutical product has flowed out of the product reservoir and into the internal chamber of the discharge chute, the product inlet valve connected to the product inlet on the discharge chute is operated (or automatically activated) to close down the product inlet of the discharge chute, and thereby stop the flow of pharmaceutical product out of the product reservoir and into the internal chamber of the discharge chute.

When at least some of the dried pharmaceutical product has flowed into the internal chamber of the discharge chute, a gas control valve connected to the gas inlet is operated to open the gas inlet on the discharge chute and thereby permit a gas, such as Nitrogen, for example, to flow into the internal chamber of the discharge chute through the gas inlet by operation of the gas source. The flow of gas into the internal chamber re-pressurizes the internal chamber so that the pressure level inside the internal chamber returns to an ambient pressure level. The ambient pressure level facilitates using gravity to induce the pharmaceutical product inside the internal chamber to flow out of the bottom end of internal chamber through the product outlet and into a primary collection container connected to the bottom of the discharge chute. To start the gravity-induced flow of pharmaceutical product out of the internal chamber and into the primary collection container, a collection control valve, connected to the product outlet of the discharge chute, is opened to unblock the product outlet. The collection control valve remains open until the desired quantity of the pharmaceutical product inside of the internal chamber of the discharge chute has passed through the product outlet and into the primary collection container.

The aforementioned control valves may comprise any one of a variety of different types of conventional valves, including without limitation, a solenoid valve, a butterfly valve, a ball valve, or a full port ball valve, to name but a few examples.

In certain embodiments, the discharge chute further comprises a flow diverter assembly configured to give the operator the option of diverting some portion of the dried powder flowing out of the discharge chute into a second (or auxiliary) collection container. In some cases, the reason for diverting some of the dried powder pharmaceutical product into the second collection container, instead of permitting it to flow into the primary collection container, is to physically separate from the primary collection container any dried powder product that the operator has determined by observation, by inspection, by sensor measurements, or by some other means, lacks a necessary or desired characteristic, such as a required or desired structure, dryness, particle size, etc., and therefore should be discarded as waste material. In other cases, it may be necessary or desirable to divert some of the dried pharmaceutical product into a second (or auxiliary) collection container when the primary collection container is full, and therefore needs to be removed and replaced.

Accordingly, the flow diverter assembly in some embodiments comprises a common channel, a primary exit channel, an auxiliary exit channel, a flow diverter and a flow diverter controller. The primary exit channel, which fluidly connects the common channel to the primary collection container, is configured so that any pharmaceutical product flowing into the primary exit channel from the common channel will flow only into the primary collection container. The auxiliary exit channel, which fluidly connects the common channel to the auxiliary collection container, is configured so that any pharmaceutical product flowing into the auxiliary exit channel will flow only into the auxiliary collection container. The common channel, the primary exit channel and the auxiliary exit channel of the flow diverter assembly make up the lower portion of the internal chamber of the discharge chute. In other words, the lower portion of the internal chamber of the discharge chute defines the common channel, which then “splits” into two channels to define the primary exit channel and the auxiliary exit channel of the flow diverter assembly. The flow diverter, which is located at a nexus between the common channel, the primary exit channel and the auxiliary exit channel, is configured to serve as a gate of sorts to direct the pharmaceutical product passing out of the common channel to flow only into the primary exit channel, or to flow only into the auxiliary exit channel, or to flow into both the primary exit channel and the auxiliary exit channel, depending on the orientation of the flow diverter. The flow diverter may also comprise a solenoid valve, as will be described in more detail below.

The flow diverter controller, which is mechanically (or electromechanically) connected to the flow diverter at the nexus between the common channel, the primary exit channel and the auxiliary exit channel, is operable to control the orientation of the flow diverter. It will be understood that certain embodiments of the present invention may comprise flow diverter assemblies having three or more exit channels configured to divert dried pharmaceutical products into three or more collection containers without departing from the scope of the claimed invention.

In some embodiments, the apparatus of the present invention further comprises a flexible isolator, attached to the discharge chute, which is configured to surround and enclose the fluid connection between the product outlet on the discharge chute and the primary collection container, and thereby substantially isolate the fluid connection between the product outlet and the primary collection container from a surrounding environment. If the apparatus includes both a primary collection container and an auxiliary collection container, then the flexible isolator attached to the flow diverter assembly may be configured to enclose, surround and protect both (i) the fluid connection between the primary exit channel of the flow diverter assembly and the primary collection container, and (ii) the fluid connection between the auxiliary exit channel of the flow diverter assembly and the auxiliary collection container.

Optionally, embodiments of the present invention may also include a coupling system for attaching the flexible isolator to the flow diverter assembly. An exemplary coupling system may include, for example, a mounting plate on the flow diverter assembly, a groove around a perimeter section of the mounting plate, an opening in a wall of the flexible isolator, the opening having a size and a shape that substantially matches the perimeter section of the mounting plate, and an elastic band (or “O-ring”) that is attached to a part of the wall of the flexible isolator that is adjacent to the opening. The groove around the perimeter section of the mounting plate is configured to receive and removably hold in place both the elastic band (stretched to fit around the perimeter section of the mounting plate) and the part of the wall of the flexible isolator adjacent to the opening in the flexible isolator to which the elastic band is attached. A clamp may be removably fastened to the perimeter section of the mounting plate so that the elastic band and the part of the wall of the flexible isolator to which the elastic band is attached are sandwiched between an inside wall of the clamp and the groove around the perimeter section of the mounting plate to ensure that the elastic band (as well as the edges of the opening in the top of the flexible isolator) stays put in the groove, and that no stray particles can escape the flexible isolator by passing through the opening while the opening of the flexible isolator is fastened to the mounting plate.

It is anticipated by the present inventors that it may be important, necessary or desirable for a human operator to have the option of inspecting or observing the dried powder form of the pharmaceutical product flowing out of the product reservoir of the drying device and into the discharge chute while the dried powder is still inside the internal chamber of the discharge chute so that the operator can make an informed decision on whether the dried powder lacks any required physical characteristics, such as flowability, particle size or dryness attributes. To meet this need, embodiments of the present invention may also include a discharge monitoring system, connected to the housing of the discharge chute, configured to provide a visual indication of a quantity or a physical state of the pharmaceutical product located inside the internal chamber of the discharge chute. The discharge monitoring system may comprise, for example, a sensor; a sight glass; a sight glass assembly, a sight glass window; a load cell scale, an analytical probe, or a combination of two or more thereof.

In another implementation of the present invention, there is provided an airlock assembly for collecting solids from a product reservoir of a drying device while the product reservoir remains under continuous vacuum pressure. In general, the airlock assembly comprises a discharge chute, a vacuum supply control valve, a product inlet valve, a gas control valve and a collection control valve: The discharge chute comprise a substantially airtight internal chamber, a housing substantially surrounding the airtight internal chamber, a vacuum supply inlet that fluidly connects the airtight internal chamber of the discharge chute to a vacuum source, a solids inlet that fluidly connects the airtight internal chamber to the product reservoir, a gas inlet that fluidly connects the airtight internal chamber to a gas source, and a solids outlet that fluidly connects the airtight internal chamber to a collection container.

The vacuum supply control valve is connected to the vacuum supply inlet of the discharge chute and can be operated to open and close the vacuum supply inlet of the discharge chute. Opening the vacuum supply inlet by opening the vacuum supply control valve permits the vacuum source connected to vacuum supply inlet to suction a sufficient amount of gas from the airtight internal chamber to create inside the airtight internal chamber a negative air pressure level that is less than or substantially equal to the vacuum pressure inside the product reservoir of the drying device.

The product inlet valve is connected to the solids inlet of the discharge chute and can be operated to open and close the solids inlet while the negative pressure level inside the airtight internal chamber of the discharge chute is less than or substantially equal to the vacuum pressure in the product reservoir. Opening the solids inlet of the discharge chute by opening the product inlet valve connected to the solids inlet while the negative pressure level inside the airtight internal chamber of the discharge chute is less than or substantially equal to the vacuum pressure in the product reservoir results in a gravity-induced flow of at least a portion of the solids from the product reservoir, through the solids inlet and into the airtight internal chamber of the discharge chute.

Because the pressure level in the internal chamber of the discharge chute is less than or substantially equal to the pressure level inside the product reservoir of the drying device, the product inlet valve and the solids inlet of the discharge chute can safely be opened without breaking the vacuum-pressured condition of the product reservoir of the drying device. Therefore, the drying device does not have to be shut down, and can remain in operation, while the solids flow out of the product reservoir, through the solids inlet and into the airtight internal chamber of the discharge chute. Typically, when some (or all) of the solids collected in the product reservoir of the drying unit has flowed through the solids inlet and into the airtight internal chamber of the discharge chute, the product inlet valve is again operated to close the solids inlet and thereby prevent continued flow of the solids from the product reservoir to the airtight internal chamber.

The gas control valve is connected to the gas inlet on the discharge chute, and it can be operated to open the gas inlet to permit the gas source connected to the opposite end of the gas inlet to force a sufficient amount of gas into the airtight internal chamber of the discharge chute to re-pressurize the airtight internal chamber to raise the pressure level inside the airtight internal chamber to an ambient pressure level. Because the pressure level is ambient, it is now possible to safely open the solids outlet in the airtight internal chamber to remove (or pour) the solids out of the airtight internal chamber. To this end, the collection control valve is attached to the solids outlet, and it can be operated to open the solids outlet while the pressure of the airtight internal chamber is at the ambient pressure level. This action of opening the collection control valve to open the solids outlet in the discharge chute causes a gravity-induced flow of at least some of the solids inside of the airtight internal chamber of the discharge chute from the airtight internal chamber through the solids outlet and into the collection container. The collection control valve may be operated to close the solids outlet of the discharge chute when all (or a sufficient or desired amount) of the solids have flowed out of the internal chamber and into the collection container.

The solids outlet of the airlock assembly may comprise a flow diverter assembly to divert some of the solids flowing out of the airtight internal chamber of the discharge chute into a second (auxiliary or waste) collection container: The flow diverter assembly may comprise, for example, a collection branch, a waste branch, a flow diverter and a flow diverter control switch. The collection branch is configured to permit solids to flow only into a first collection container connected to the flow diverter assembly. The waste branch is configured to permit the solids to flow only into the waste container connected to the flow diverter assembly. The flow diverter is located at a nexus between the collection branch and the waste branch, and is configured to direct the flow of the solids entering the flow diverter assembly so that those solids will flow only into the collection branch, so that those solids will flow only into the waste branch, or so that those solids will flow into both the collection branch and the waste branch, depending on an orientation of the flow diverter. The flow diverter control switch is mechanically coupled to the flow diverter, and it is operable to control the orientation of the flow diverter.

The airlock assembly implementation also may include one or more flexible isolators, attached to the discharge chute, configured to enclose the fluid connections between the solids outlet on the discharge chute and the collection containers, and thereby substantially enclose and isolate the fluid connections between the solids outlet and the collection containers from the surrounding atmosphere outside the discharge chute.

In still another implementation of the present invention, there is provided an automated collection system for collecting a dried pharmaceutical product from a product reservoir of a dryer while the product reservoir of the dryer is under continuous vacuum pressure. In general, the automated collection system comprises a computer system, at least one input/output block, a discharge chute, a primary collection container and an isolator. Typically, the discharge chute comprises a plurality of sanitary spool tubes connected in series to form a substantially continuous internal chamber (or passageway) extending from one end of the discharge chute to the opposite end of the discharge chute. Preferably, at least some of the sanitary spool tubes comprising the discharge chute have built-in instrumentation ports for connecting sensor instruments for taking various measurements, such as, for example, pressure sensors, temperature sensors, contact and non-contact infrared (IR) and Fourier Transform infrared (FTIR) Raman spectrometry sensors, and product height or level-sensors.

The discharge chute of the automated collection system comprises (i) an internal chamber, (ii) a housing surrounding the internal chamber, (iii) a product inlet solenoid valve that fluidly connects the internal chamber of the discharge chute to the product reservoir of the dryer, (iv) a vacuum supply inlet solenoid valve that fluidly connects the internal chamber of the discharge chute to a vacuum source, (v) a gas inlet solenoid valve that fluidly connects the internal chamber of the discharge chute to a gas source, and (vi) a product outlet solenoid valve that fluidly connects the internal chamber of the discharge chute to the primary collection container.

As is known in the art, each one of the solenoid valves comprises a solenoid coil wrapped around an armature, a plunger and a biasing spring located inside the armature, a valve body, and an electrical cable connection in electrical communication with the solenoid coil. An electrical cable attaches the electrical cable connection of the solenoid valve to the input/output block, which is in turn electrically connected to the computer system. The solenoid coil, armature, plunger, spring and valve body are arranged so that, when electric current generated by the input/output block is passed through the solenoid coil via the electrical cable connection, it will produce an electromagnetic field around the coil, the armature, the plunger and the biasing spring, which will push or pull on the plunger, and thereby force the plunger to move inside the armature to open or close a channel passing through the valve body. When this happens, depending on the initial positions of the plunger and the biasing spring, the movement of the plunger will prevent or enable the flow of a fluid, a gas or a volume of dried solids through the channel in the valve body. Thus, the input/output block and the solenoid valves cooperate with each other to convert control signals generated and transmitted by the computer system into the mechanical forces sufficient to block and/or unblock various inlets, outlets, channels and pathways used to move gases and dried pharmaceutical particles through the automated collection system. Because the computer system, the plurality of sensors, the input/output block and the solenoid valves cooperate with each other to provide automatic and precisely timed control over the opening and closing of the inlets, outlets, channels and pathways of the system, it is not necessary to have human operators attempting to manually control the flow of such fluids, gases and dried particles by manually opening and closing the valves. This automated operation and control of the valves permits the collection system to function faster, more reliably and in a safer manner than a system that requires manual operation of the valves.

The computer system includes a microprocessor, a memory, and a process control application program stored in the memory, the process control application program comprising programming instructions that, when executed by the microprocessor, will cause the microprocessor to generate and periodically transmit to the input/output block(s) control signals that cause the input/output block(s) to generate and selectively transmit electrical current to the solenoid valves. The electrical current causes the solenoid valves to open and close at the appropriate times, depending, for example, on the pressure, temperature, height and level measurements supplied to the input/output block and the computer system by the sensor instruments connected to the built-in instrumentation ports in the sanitary spool tubes of the discharge chute.

The automated collection system operates the solenoid valves to admit and remove gas from the discharge chute so as to periodically depressurize and re-depressurize the discharge chute in a time-coordinated manner so that the dried pharmaceutical product can flow out of the product reservoir of the dryer, into and through the discharge chute, and into the primary collection container without breaking the vacuum-pressured conditions inside the product reservoir of the dryer, which avoids having to suspend the operation of the dryer to remove dried pharmaceutical product, and enables continuous manufacturing, processing and packaging of dried pharmaceutical products on a production line.

In some cases, the automated collection system may further include an auxiliary collection container, a flow diverter assembly having a common channel, a primary exit channel, an auxiliary exit channel and one or more flow diverter solenoid valves located at or near a nexus between the common channel, the primary exit channel and the auxiliary exit channel of the flow diverter assembly. The one or more solenoid valves connected to the flow diverter assembly may be configured to direct the flow of dried pharmaceutical product through the appropriate exit channel and into the primary collection container, into the auxiliary collection container, or into both the primary collection container and the auxiliary collection container, responsive to electrical current supplied to the flow diverter solenoid valve(s) by the input/output block operating under the control of control signals produced by the computer system. Suitably, the electrical current supplied to the flow diverter solenoid valve to direct the flow of dried pharmaceutical product into the primary exit channel, into the auxiliary exit channel, or into both exit channels, may be activated and deactivated in response to sensor readings collected by a sensor located in the discharge chute, the sensor being configured to determine whether the dried pharmaceutical product passing into the discharge chute meets (or does not meet) a specified requirement for the dried pharmaceutical product. For example, if the sensor detects that the dried pharmaceutical product passing into the discharge chute is “OFF-SPEC” because it is not been dried to a specified level of dryness (i.e., it is still “too wet”), then a program running on the computer system may be configured to respond to the sensor measurement by providing or removing the electric current necessary to open or close the flow diverter solenoid valve to direct (or redirect) the “too wet” dried pharmaceutical product so that it will flow only into the auxiliary exit channel connected to the auxiliary collection container.

As will be described in more detail below and with reference to the figures, additional sensors and additional solenoid valves may be attached to various other components of the automated collection system in order to monitor conditions and control flows of gases and solids in and through those other components of the system. For instance, in cases where the isolator is filled with nitrogen, or some other gas, a pressure sensor, a nitrogen source, a nitrogen supply solenoid valve and an exhaust solenoid valve may be attached to the isolator and, operating together under the control of control signals generated by the computer system and electrical current delivered to the solenoid valves by the input/output blocks, the pressure sensor, nitrogen source, nitrogen supply solenoid valve and exhaust solenoid valve may be automatically operated by the computer system to maintain a constant, specified or desired pressure level inside the isolator.

In some embodiments, but not necessarily all embodiments, the process control application program may comprise a plurality of separate or integrated programming modules (subroutines and/or functions), stored in the primary and/or secondary memory of the computer system, each programming module containing program instructions executable by the microprocessor to cause the microprocessor to generate and transmit to the input/output block(s) control signals that cause the input/output block(s) to deliver electric current to the solenoid coils in the solenoid valves, which cause the solenoid valves to open or close. This collection of programming modules may include, for example, a vacuum supply control module that, when executed by the microprocessor, will cause the microprocessor to generate and send to the input/output board control signals that cause the vacuum supply inlet solenoid actuator for the vacuum supply inlet valve to automatically open the vacuum supply inlet valve of the discharge chute to permit the vacuum source to remove gases from the internal chamber, via the vacuum supply inlet valve, until a pressure gauge attached to the internal chamber of the discharge chute indicates that the measured pressure level inside the internal chamber of the discharge chute is less than or equal to the vacuum pressure existing inside the product reservoir of the dryer.

The collection of program modules may further include a product inlet module, stored in the memory and communicatively coupled to the discharge monitoring system and the product inlet valve. The product inlet module has program instructions that, when executed by the microprocessor, will cause the microprocessor to generate and send to the input/output board control signals that cause the input/output board to transmit electrical signals to the product inlet solenoid valve to (i) automatically open the product inlet solenoid valve on the discharge chute if a pressure sensor on the discharge chute indicates that the pressure level inside the internal chamber of the discharge chute is less than or equal to the vacuum pressure existing inside the product reservoir of the dryer to permit at least a portion of the pharmaceutical product inside the product reservoir to flow through the product inlet solenoid valve and into the internal chamber of the discharge chute, and (ii) automatically close the product inlet solenoid valve on the discharge chute if a discharge monitoring system detects that the specified quantity of the pharmaceutical product is inside the discharge chute.

The collection of program modules may further include a gas control module, stored in the memory and communicatively coupled to the discharge monitoring system and the gas inlet solenoid valve. The product inlet module includes program instructions that, when executed by the microprocessor, will cause the microprocessor to generate and send to the input/output board control signals that cause the input/output board to activate the gas inlet solenoid valve to open in response to the product inlet module closing the product inlet solenoid valve, and thereby permit the gas source to admit gas into the internal chamber of the discharge chute, via the gas inlet solenoid valve, until the pressure sensor indicates that the pressure inside the internal chamber of the discharge chute has reached an ambient pressure level.

And finally, the collection of program modules stored in the memory includes a collection control module communicatively coupled to the discharge monitoring system and the product outlet valve. The product inlet module has program instructions that, when executed by the microprocessor, will cause the microprocessor to generate and send to the input/output board control signals that cause input/output board to activate the solenoid coil in the product outlet solenoid valve to open the product outlet solenoid valve when a discharge monitoring system connected to the discharge chute indicates that a specified quantity of the pharmaceutical product is located in the internal chamber of the discharge chute and the pressure sensor indicates that the measured pressure level inside the internal chamber of the discharge chute is at the ambient pressure level, thereby causing at least some of the pharmaceutical product located inside the internal chamber of the discharge chute to flow out of the internal chamber, through the product outlet solenoid valve and into the primary collection container.

In cases where the automated collection system includes a flow diverter assembly, the collection of program modules stored in the memory of the computer system further includes a flow diverter assembly control module, communicatively coupled to the discharge monitoring system and the flow diverter solenoid valve(s). The flow diverter control module has program instructions that, when executed by the microprocessor, will cause the microprocessor to generate and send to the input/output board control signals that cause the flow diverter solenoid valve to open or close if the discharge monitoring system detects that a predetermined amount of the pharmaceutical product has flowed out of the internal chamber of the discharge chute through the product outlet solenoid valve and into the primary collection container.

In yet another implementation, certain embodiments of the present invention provide a method of using the discharge chute to collect a pharmaceutical product from a product reservoir of a dryer while the product reservoir of the dryer is under continuous vacuum pressure. As in other embodiments, the discharge chute comprises (i) an internal chamber, (ii) a housing surrounding the internal chamber, (iii) a product inlet valve that fluidly connects the internal chamber of the discharge chute to the product reservoir of the dryer, (iv) a vacuum supply inlet valve that fluidly connects the internal chamber of the discharge chute to a vacuum source, (v) a gas inlet valve that fluidly connects the internal chamber of the discharge chute to a gas source, and (vi) a product outlet valve that fluidly connects the internal chamber of the discharge chute to a primary collection container.

The method comprises the steps of:

a) detecting a pressure level inside the internal chamber of the discharge chute with a pressure gauge;

b) opening the vacuum supply inlet valve of the discharge chute;

c) activating the vacuum source to remove gases from the internal chamber via the vacuum supply inlet valve until the pressure gauge detects that the pressure inside the internal chamber of the discharge chute is less than or equal to the vacuum pressure existing inside the product reservoir of the dryer;

d) opening the product inlet valve on the discharge chute while the pressure gauge indicates that the measured pressure level inside the internal chamber of the discharge chute is less than or equal to the vacuum pressure existing inside the product reservoir of the dryer;

e) causing at least a portion of the pharmaceutical product inside the product reservoir to flow through the product inlet and into the internal chamber of the discharge chute;

f) closing the product inlet valve on the discharge chute;

g) opening the gas inlet valve of the discharge chute;

h) activating the gas source to force gas into the internal chamber of the discharge chute via the gas inlet valve until the pressure gauge indicates that the pressure inside the internal chamber of the discharge chute has reached an ambient pressure level;

i) opening the product outlet valve while the pressure gauge indicates that pressure inside the internal chamber of the discharge chute is at the ambient pressure level; and

j) causing at least some of the pharmaceutical product located inside the internal chamber of the discharge chute to flow out of the internal chamber, through the product outlet valve and into the primary collection container.

In certain embodiments, the method may further include the step of attaching the discharge chute (or the product inlet on the discharge chute) to the product reservoir of the dryer, and/or attaching a flexible isolator to the discharge chute to enclose the fluid connection between the product outlet valve on the discharge chute and the primary collection container to substantially isolate the fluid connection between the product outlet valve and the primary collection container from a surrounding environment.

The method may also include the steps of (a) attaching the aforementioned flow diverter assembly to the discharge chute and the primary collection container, and (b) operating the flow diverter control to change the orientation of the flow diverter, thereby controlling whether the pharmaceutical product flowing out of the internal chamber of the discharge chute and into the flow diverter assembly will pass into primary exit channel of the flow diverter assembly, the auxiliary exit channel of the flow diverter assembly, or both.

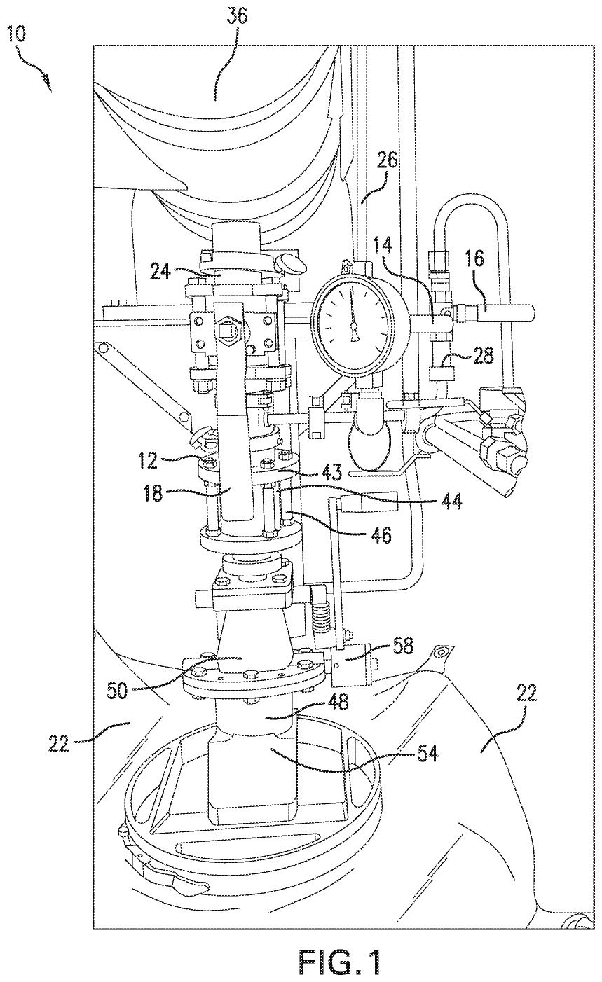

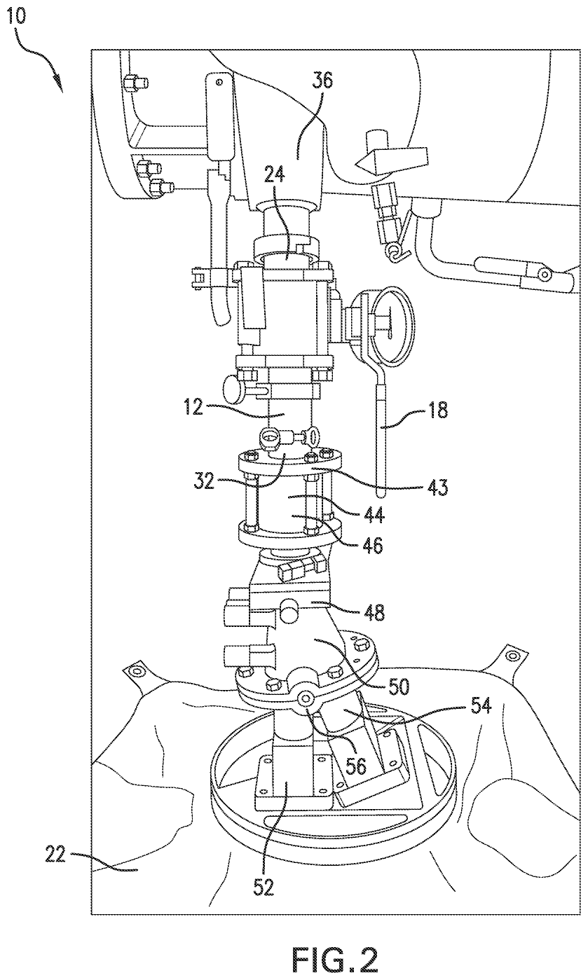

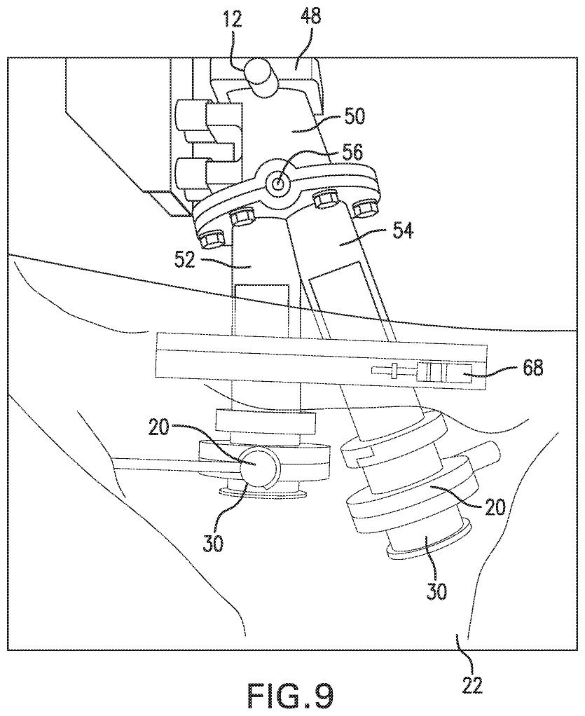

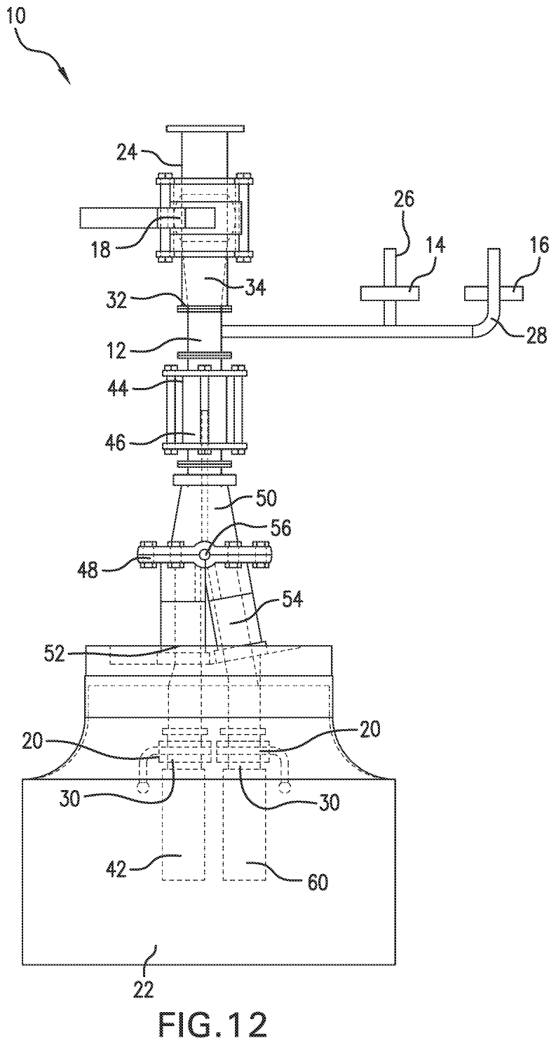

Turning now to the figures, FIG. 1 shows a front-side perspective view of one example of a pharmaceutical product collection apparatus 10 for a continuous drug manufacturing production line according to one embodiment of the present invention. FIG. 2 shows a front-side perspective view of the exemplary pharmaceutical product collection apparatus 10 shown in FIG. 1. As shown in FIGS. 1 and 2, the exemplary collection apparatus 10 comprises a discharge chute 12, a vacuum supply control valve 14, a gas control valve 16, a product inlet valve 18, a collection control valve 20 and a flexible isolator 22. The discharge chute 10 has a product inlet 24 at one end (in this case the product inlet 24 is at the top end of the discharge chute 12), a vacuum supply inlet 26, a gas inlet 28 and a product outlet 30 (the product outlet 30, best shown in FIG. 9) is at the bottom end of the discharge chute 12). The discharge chute also has an housing 32 (a.k.a., an outer shell or jacket), which substantially surrounds an internal chamber 34 (shown best in FIG. 12) so that the internal chamber 34 of the discharge chute 12 is substantially airtight when all of the inlets and outlets are closed by operation of all of the aforementioned valves.

The discharge chute 12 is typically connected to a pharmaceutical product dryer 36 (such as a thin film evaporator), by attaching the product inlet 24 of the discharge chute 12 to a product reservoir (not shown) inside the drying device 36 to provide a fluid connection between the internal chamber 34 of the discharge chute 12 and the product reservoir. The vacuum supply inlet 26 fluidly connects the internal chamber 34 of the discharge chute 12 to a vacuum source 38, such as a vacuum pump, which is operable to evacuate gas out of the internal chamber 34, thereby reducing the air pressure level . The gas inlet 28 fluidly connects the internal chamber 34 of the discharge chute 12 to a gas source (not shown), such as a nitrogen tank, or a tank containing some other gas. Typically, but not necessarily, the gas used will be an inert gas, depending on the material being processed. The product outlet 30 (best shown in FIG. 12) is adapted to provide a fluid connection between the internal chamber 34 of the discharge chute 12 and a primary collection container (not shown in FIGS. 1 and 2).

In some embodiments, and as shown in FIG. 1, the vacuum supply inlet 26 and the gas inlet 28 of the discharge chute 12 may comprise a single inlet (or port) in the housing 32 of the discharge chute 12 in order to accommodate situations in which the vacuum supply inlet 26 connecting the internal chamber 34 to the vacuum source (not shown in the figures) merges with the gas inlet 28 connecting the internal chamber 34 with the gas source before the vacuum supply inlet 26 and gas inlet 28 reach the housing 32. Thus, the vacuum supply and the gas may travel through the stretch of piping, and may enter or exit the internal chamber 34 through the same opening in the housing 32. It may be both convenient and efficient to introduce vacuum and gas into the internal chamber 34 through the same inlet in the internal chamber 34 because it is never necessary to pressurize the internal chamber 34 with gas and depressurize the internal chamber 34 with vacuum at the same time, as will be explained in more detail below.

The vacuum supply control valve 14 may be operated to open or close the vacuum supply inlet 26 on the discharge chute 12 to cause or prevent a suctioning of gas out of the internal chamber 34 of the discharge chute 12 through the vacuum supply inlet 26 by operation of the vacuum source (not shown in the figures). The product inlet control valve 18 is operable to open or close the product inlet 24 on the discharge chute 12 to cause or prevent a flow of at least a portion of the pharmaceutical product in the product reservoir of the dryer 36 through the product inlet 24 and into the internal chamber 34 of the discharge chute 12. The gas control valve 16 can be operated to open or close the gas inlet 28 on the discharge chute 12, which will cause or prevent a flow of gas into the internal chamber 34 of the discharge chute 12 through the gas inlet 28 by operation of the gas source (not shown). The collection control valve 20 (best shown in FIG. 9) is operable to open or close the product outlet 30 on the internal chamber 34 of the discharge chute 12 to cause or prevent a flow of at least some of the pharmaceutical product inside of the internal chamber 34 of the discharge chute 12 through the product outlet 30 and into a primary collection container (not shown).

In the embodiment shown in the figures, the discharge chute 12 further includes a discharge monitoring system 43, comprising a sight glass assembly 44, which contains a glass sight window 46, through which a human operator may see in order to monitor pharmaceutical product (not shown) as it passes through the internal chamber 34 of the discharge chute 12.

The exemplary discharge chute 12 also has a flow diverter assembly 48 (shown best in FIGS. 2, 7 and 12) that is located between the sight glass assembly 44 and the product outlet 30 of the discharge chute 12. The flow diverter assembly 48 comprises a common channel 50, a primary exit channel 52, an auxiliary exit channel 54, a flow diverter 56 (shown best in FIG. 12) and a flow diverter controller 58. The primary exit channel 52 of the flow diverter assembly 48 is adapted to provide a fluid connection between the common channel 50 and the primary collection container 42, and configured so that the pharmaceutical product flowing into the primary exit channel 52 from the common channel 50 will flow only into the primary collection container 42 attached to the product outlet 30 of the discharge chute 12. The auxiliary exit channel 54 of the flow diverter assembly 48 is adapted to provide a fluid connection between the common channel 50 and an auxiliary collection container 60 (see FIG. 12), and configured so that the pharmaceutical product flowing into the auxiliary exit channel 54 from the common channel 50 will flow only into the auxiliary collection container 60.

The flow diverter 56 (shown best in FIG. 12) is located at the nexus of the common channel 50, the primary exit channel 52 and the auxiliary exit channel 54, the flow diverter being configured to divert the pharmaceutical product passing through the common channel 50 into the primary exit channel 52, or into the auxiliary exit channel 54, or into both the primary exit channel 52 and the auxiliary exit channel 54, depending on an orientation of the flow diverter 56. The flow diverter controller 58 is mechanically connected to the flow diverter 56, and is operable to control the orientation of the flow diverter 56 inside the flow diverter assembly 48.

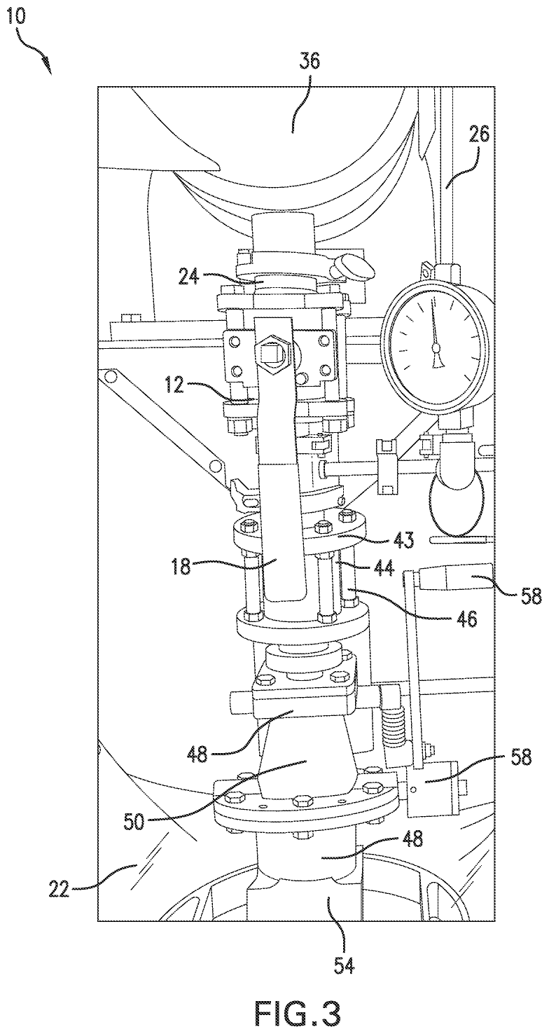

FIG. 3 shows a more detailed perspective view of the product inlet 24 and product inlet control valve 18 of the exemplary pharmaceutical product collection apparatus 10 shown in FIG. 1, wherein the product inlet control valve 18 is turned to the open position.

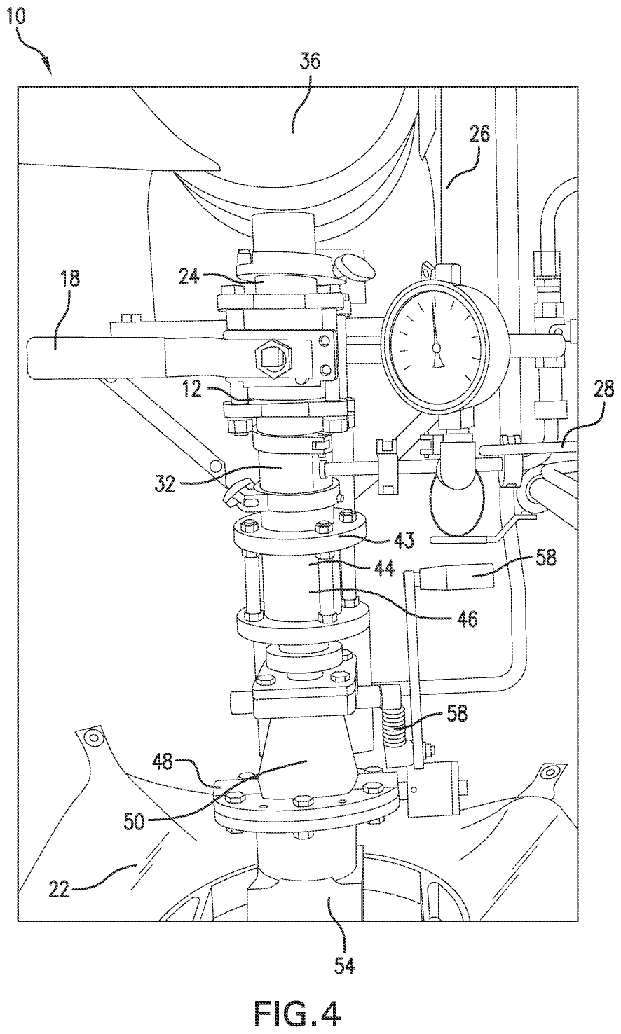

FIG. 4 shows a more detailed perspective view of the product inlet 24, product inlet control valve 18 and sight glass assembly 44 of the exemplary pharmaceutical product collection apparatus 10 shown in FIG. 1, wherein the product inlet control valve 18 is turned to the closed position.

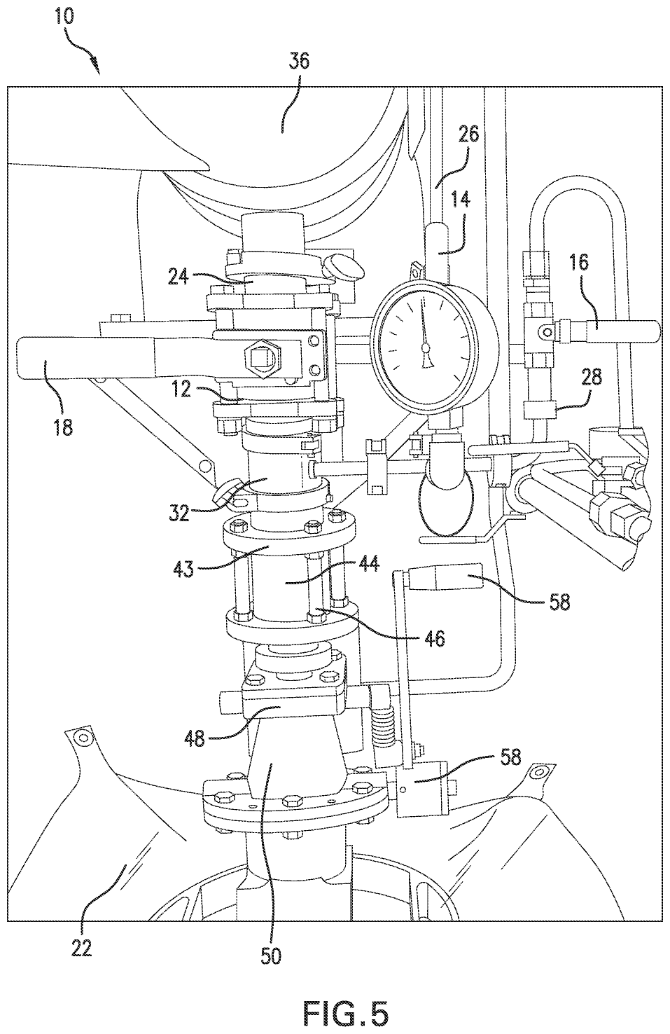

FIG. 5 shows a more detailed perspective view of the vacuum supply inlet 26, vacuum supply control valve 14, gas inlet 28 and gas control valve 16 of the exemplary pharmaceutical product collection apparatus 10 shown in FIG. 1, wherein the vacuum supply control valve 14 is open and the gas control valve 16 is closed.

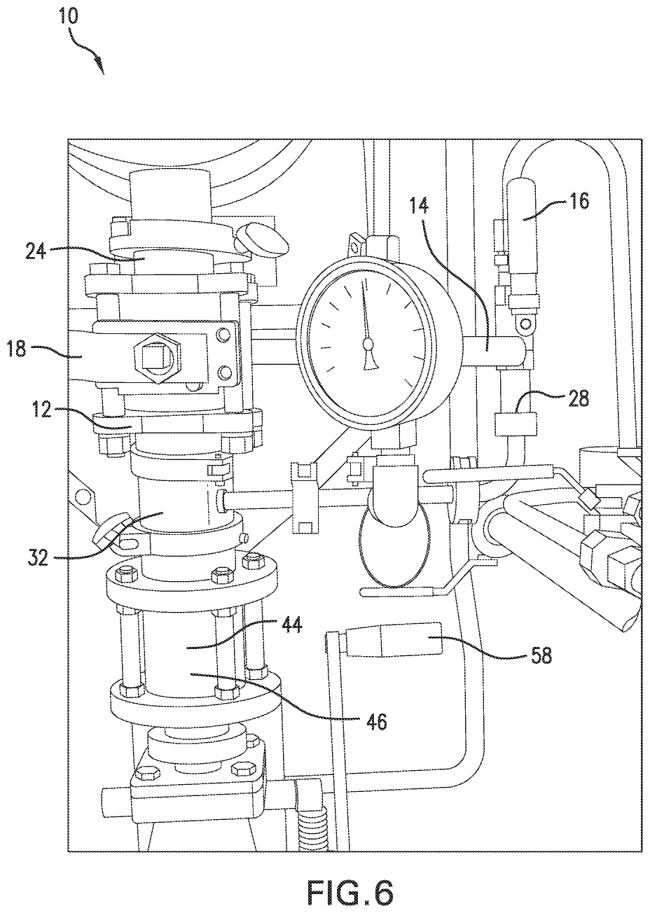

FIG. 6 shows a more detailed perspective view of the vacuum supply inlet 26, vacuum supply control valve 14, gas inlet 28 and gas control valve 16 of the exemplary pharmaceutical product collection apparatus 10 shown in FIG. 1, wherein the vacuum supply control valve 14 is closed and the gas control valve 16 is open.

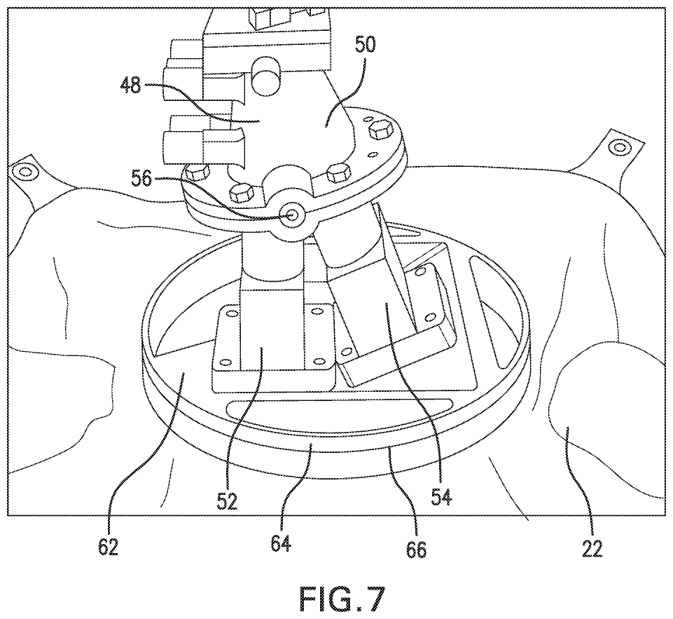

FIG. 7 shows a perspective left-side view of the flow diverter assembly 48 and an exemplary coupling system for attaching the flexible isolator 22 to the flow diverter assembly 48 in the exemplary pharmaceutical collection apparatus 10 shown in FIG. 1, wherein the coupling system comprises a single mounting plate 62, a groove 64 around the perimeter of the single mounting plate 62 and an elastic band 66 arranged to hold the opening of the flexible isolator 22 inside the groove 64.

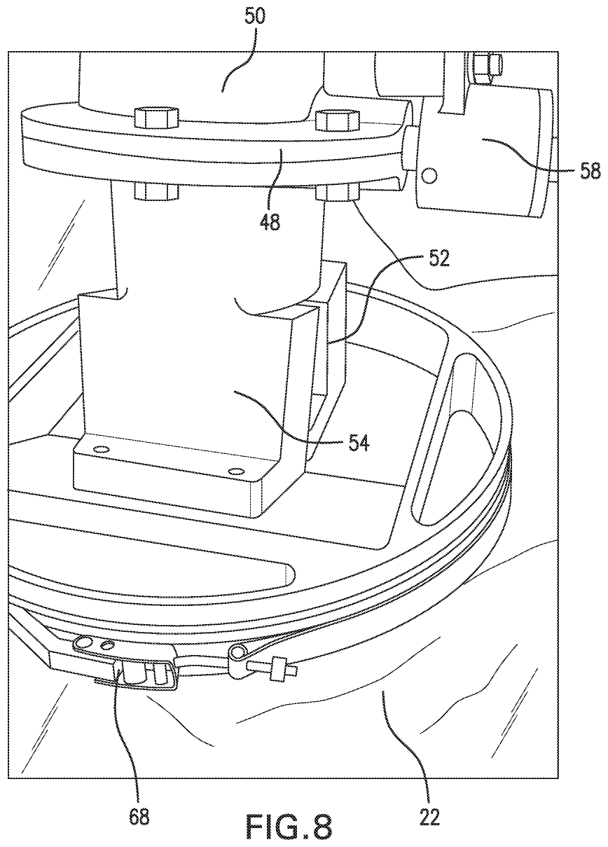

FIG. 8 shows a perspective front-side view of the flow diverter assembly 48 and exemplary coupling system shown in FIG. 7, as well as a close-up view of the mounting plate clamp 68 fastened to the perimeter of the mounting plate 62 of the coupling system. The mounting plate clamp 68 ensures that the elastic band 66 and the O-ring of the flexible isolator 22 both remain securely fastened to the groove 64 of the mounting plate 62.

FIG. 9 shows a perspective left-side view of the primary exit channel 52 and the auxiliary exit channel 54 of the flow diverter assembly 48, the product outlets 30 of the discharge chute 12 and the collection control valves 20, as well as the left side of a flexible isolator 22 arranged in accordance with an exemplary embodiment of the pharmaceutical product collection apparatus 10 of the present invention.

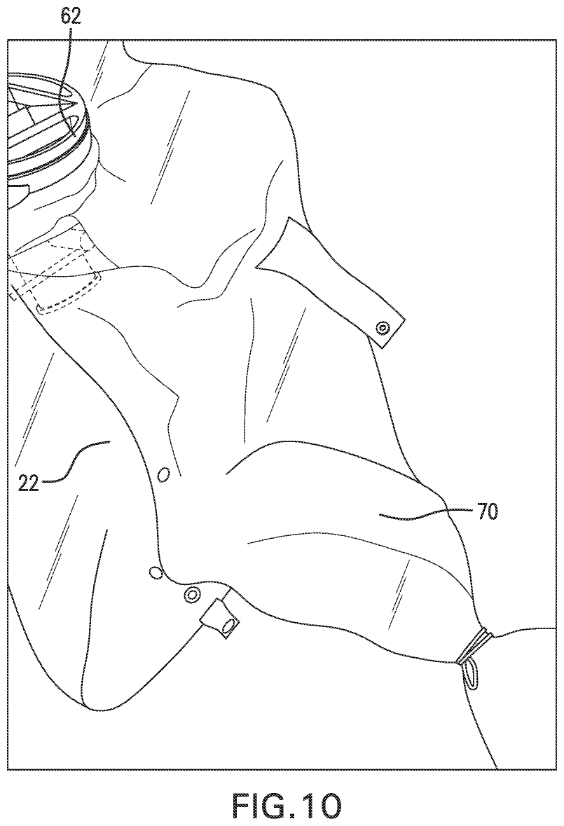

FIG. 10 shows a discharge port 70, attached to the flexible isolator, to facilitate removing the primary collection container 42 and/or auxiliary collection container 60 filled with pharmaceutical product from the inside of the flexible isolator 22.

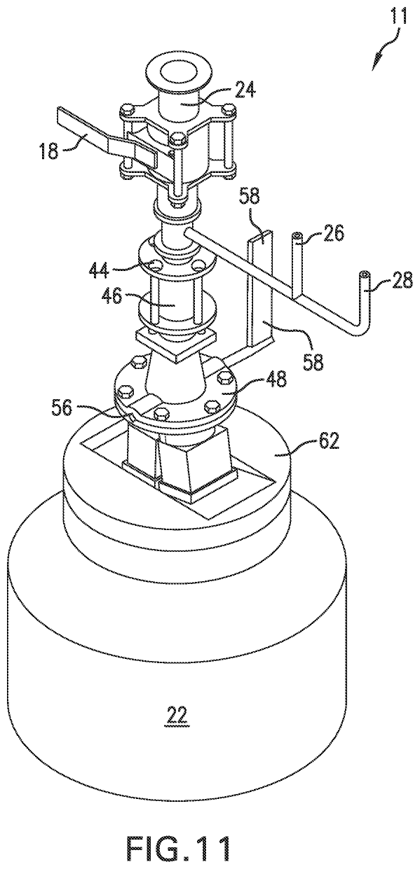

FIG. 11 shows a high-level computer aided drawing (CAD) illustrating by way of example a perspective view of some of the main components of a pharmaceutical product collection apparatus 11 according to one embodiment of the present invention. FIG. 12 shows a high-level computer aided drawing (CAD) illustrating a cross-sectioned view of the exemplary pharmaceutical collection 11 apparatus shown in FIG. 11.

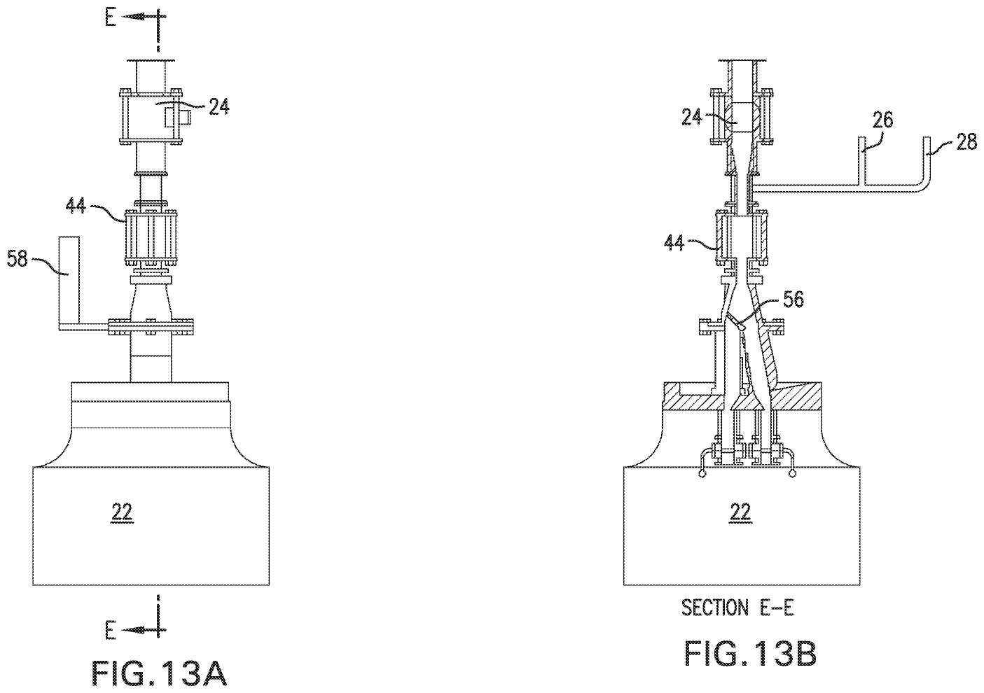

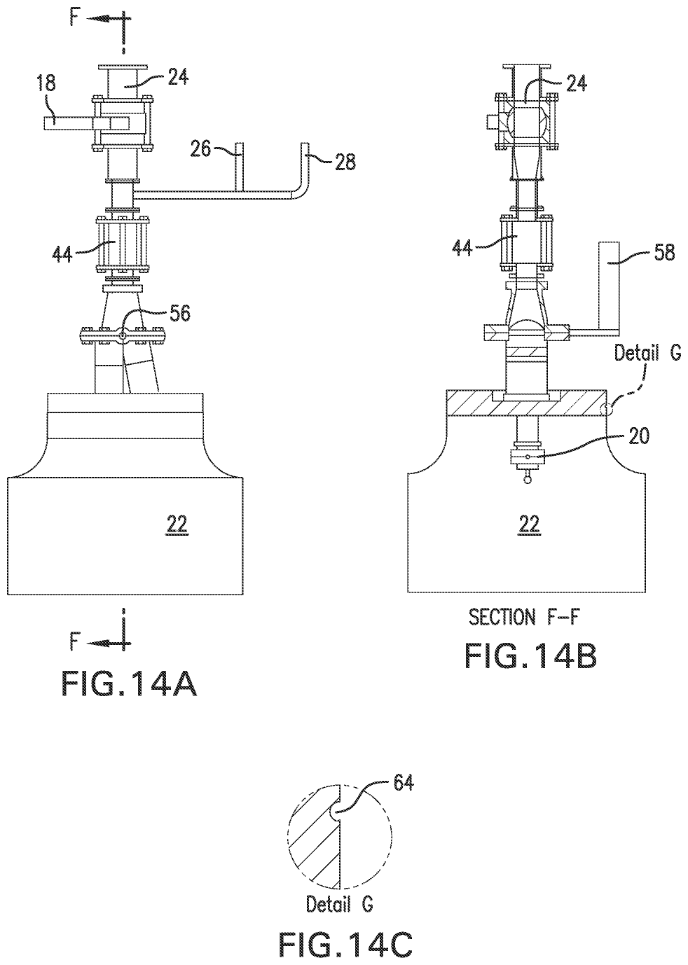

FIG. 13A shows a high-level computer aided drawing (CAD) illustrating a left side view of the exemplary pharmaceutical collection apparatus 11 shown in FIG. 11. FIG. 13B shows a high-level computer aided drawing (CAD) illustrating a cross-sectioned view along a cut-line E-E of the exemplary pharmaceutical product collection apparatus shown in FIG. 13A. FIG. 14A shows a high-level computer aided drawing (CAD) illustrating a right side view of the exemplary pharmaceutical collection apparatus 11 shown in FIG. 11. FIG. 14B shows a high-level computer aided drawing (CAD) illustrating a cross-sectioned view along a cut-line F-F of the exemplary pharmaceutical product collection apparatus shown in FIG. 14A. FIG. 14C shows a high-level computer aided drawing (CAD) illustrating a cross-sectioned view along the cut-line G of the exemplary pharmaceutical product collection apparatus shown in FIG. 14B.

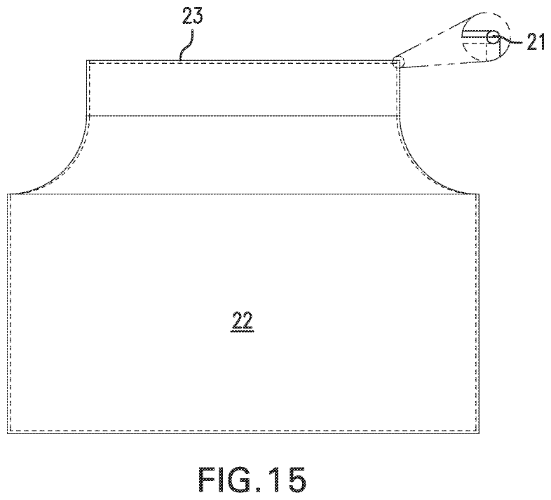

FIG. 15 shows a high-level computer aided drawing (CAD) illustrating an isometric view of the flexible isolator 22 for the exemplary pharmaceutical collection apparatus 11 shown in FIG. 11. As shown in FIG. 15, the top of the flexible isolator 22 has an opening 23 configured to engage with the mounting plate 62. In preferred embodiments, the opening 23 has a built-in stretchable O-ring 21 to help ensure that the opening 23 of the flexible isolator 22 remains securely attached to the mounting plate 62 while the system is in use. Typically, the built-in O-ring 21 is stretched and placed into the machined groove 64 to of the mounting plate 62 to help create an air tight seal around the perimeter of the mounting plate 62. A stainless steel clamp may be installed over the top of the built-in O-ring 21 for added protection against leaks.

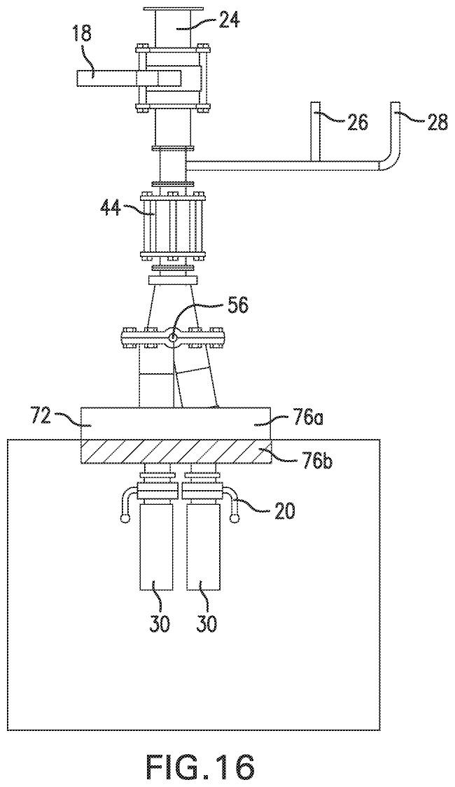

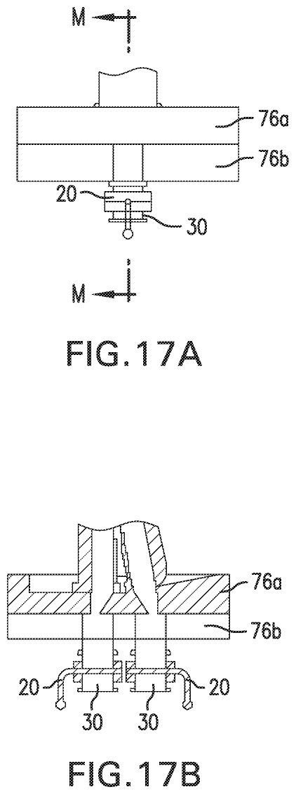

In an alternative embodiment, and as shown in FIG. 16, the flexible isolator coupling system 72 may comprise two separate mounting plates, instead of a single mounting plate with a machined groove. In this embodiment, there is provided an upper mounting plate 76a and a lower mounting plate 76b, wherein the upper mounting plate 76a is located outside the flexible isolator 22, and the lower mounting plate 76b is located inside the flexible isolator 22, and the two mounting plates 76a and 76b are clamped together to hold fast the opening 23 of the flexible isolator 22. FIG. 17A shows a high-level computer aided drawing (CAD) illustrating a left side view of the alternative coupling system 72 shown in FIG. 16. FIG. 17B shows a high-level computer aided drawing (CAD) illustrating a cross-sectioned view along a cut-line M-M of the alternative coupling system 72 shown in FIG. 17A.

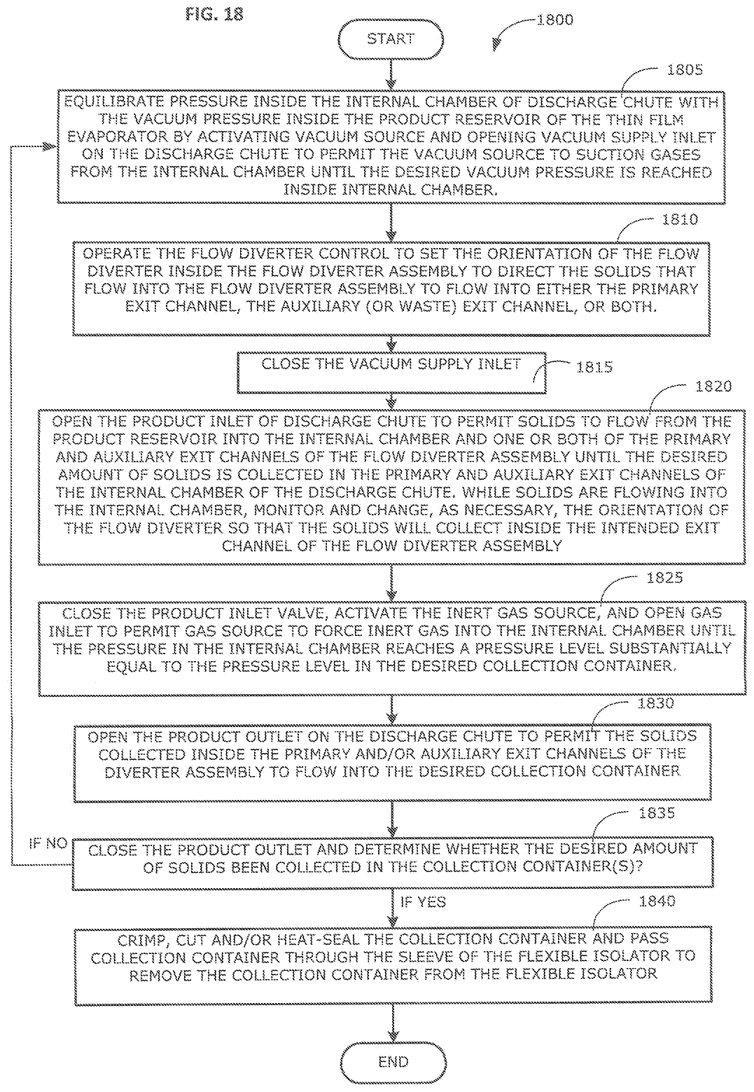

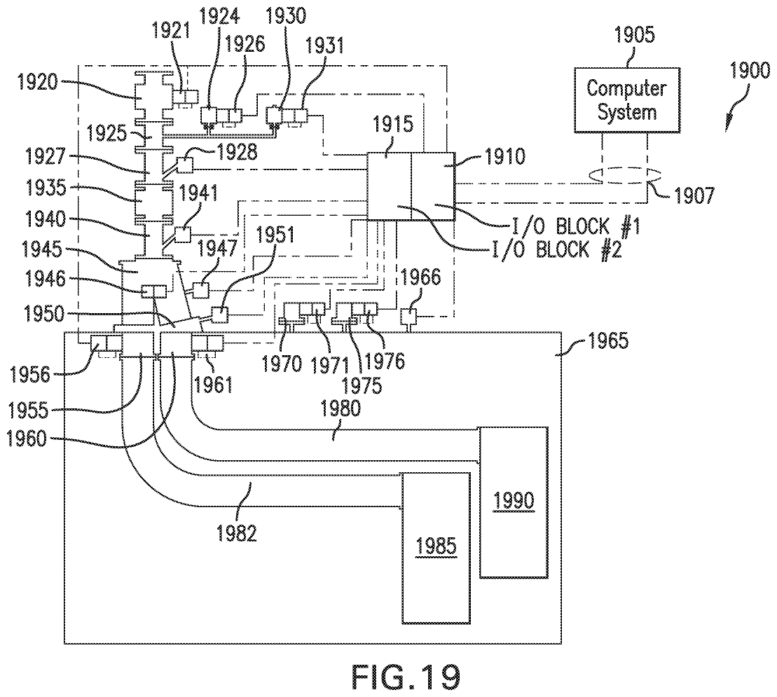

FIG. 18 shows a high-level flow diagram 1800 illustrating a process for isolating and collecting dried solids from a thin film evaporator using a pharmaceutical product collection apparatus constructed in accordance with one embodiment of the present invention. It is understood that these steps may be carried out manually by human operators, or, alternatively, may be carried out automatically under the control of a computer system, as will be described in more detail below and with reference to FIGS. 19-22.

As shown in FIG. 18, the first step (step 1805) in the process is to equilibrate the pressure inside the internal chamber of the discharge chute with the vacuum pressure inside the product reservoir of the thin film evaporator. This is accomplished by activating the vacuum source attached to the vacuum supply inlet of the discharge chute and opening the vacuum supply inlet to permit the vacuum source to suction gases from the internal chamber of the discharge chute until the air pressure inside the internal chamber of the discharge chute falls to the same level as the pressure inside the thin film evaporator. Next, at step 1810, the flow diverter control of the flow diverter assembly is operated to set the orientation of the flow diverter inside the flow diverter assembly to direct solids that flow into the flow diverter assembly to flow into either the primary exit channel, the auxiliary (or waste) exit channel, or both. Then, at step 1815, the vacuum supply inlet is closed.

With the vacuum supply inlet closed and the vacuum pressure level inside the internal chamber of the discharge chute being roughly equal to the vacuum pressure level inside the thin film evaporator, the solids can be moved from the thin film evaporator to the discharge chute. Therefore, in step 1820, the product inlet of the discharge chute is opened to permit solids to flow from the product reservoir of the thin film evaporator and into the internal chamber. These solids will pass through and fall to the bottom of the internal chamber, where they will flow into one or both of the primary and auxiliary exit channels of the flow diverter assembly. The product inlet is left open until the desired amount of solids is collected in the primary and auxiliary exit channels of the internal chamber of the discharge chute. While the pharmaceutical solids are flowing into the internal chamber, it is anticipated that the operator (if it is a manually-operated collection system), or a computer system (if it is an automated collection system) can monitor and change, as necessary, the orientation of the flow diverter so that the solids will collect inside the intended exit channel of the flow diverter assembly.

When the desired amount of solids have passed into the discharge chute, the product inlet valve is closed, the gas source is activated, and the gas inlet is opened to permit the gas source to force gas into the internal chamber of the discharge chute until the pressure in the internal chamber reaches a pressure level substantially equal to the pressure level in the preferred collection container attached to the discharge chute (see step 1825 of FIG. 18). Then the product outlet on the discharge chute is opened in order to permit the solids collected inside the primary and/or auxiliary exit channels of the diverter assembly to flow into the preferred collection container (step 1830). At this point, as shown in step 1835, the product outlet is closed, and the operator (or computer system) determines whether the desired amount of solids has been collected in the collection container. If not, then the entire process, starting at step 1805, is repeated all over again. However, if it found in step 1835 that the desired amount of solids has been collected in the collection container, then the collection container is crimped, cut and/or heat-sealed, and then passed through the discharge port of the flexible isolator to remove the collection container from the flexible isolator (see step 1840). This completes the process.

FIG. 19 shows a high-level schematic diagram of an automated collection system 1900 for collecting solids from a drying device according to one exemplary embodiment of the present invention. As shown in FIG. 19, the automated collection system 1900 comprises a computer system 1905, two input/output blocks 1910 and 1915, a primary collection container 1985, an auxiliary collection container 1990 and a flexible isolator 1965. The automated collection system 1900 also includes a discharge chute, which in this case comprises a plurality of sanitary spool tubes 1920, 1925, 1927, 1935, 1940 and 1945 connected together in series to define a substantially continuous internal chamber and a housing surrounding the internal chamber. The internal chamber and surrounding housing extend from the top end of the discharge chute to the opposite bottom end of the discharge chute. The bottom end of the discharge chute comprises a mounting plate 1950, which is configured, as discussed above, to receive and hold an opening at the top of the flexible isolator 1965. Suitably, three of the plurality of sanitary spool tubes, in this case sanitary spool tubes 1927, 1940 and 1945, have built-in instrumentation ports for connecting sensor instruments 1928, 1941 and 1947, respectively, for taking various measurements. These measuring instruments may include, for example, one or more pressure sensors, temperature sensors, contact and non-contact infrared (IR) and Fourier Transform infrared (FTIR) Raman spectrometry sensors, or product height or level-sensors, depending on the needs and preferences of programming instructions running on the computer system and/or the system operator.

Sanitary spool tube 1920 of the discharge chute fluidly connects the internal chamber of the discharge chute to a product reservoir of a connected thin film evaporator (or other drying device) to provide an inlet for the solids in the product reservoir to flow into the discharge chute. Accordingly, a product inlet solenoid valve 1921 is connected to (or, in some embodiments, may be integrated into) sanitary spool tube 1920 so that inlet and the fluid connection between the product reservoir and the internal chamber of the discharge chute can be opened or closed in response to electrical current flowing (or not flowing) through the product inlet solenoid valve 1921. A process control application program executing on the computer system 1905 is therefore configured to transmit suitable control signals to the input/output block 1910 via data communication links 1907 to cause the input/output blocks 1910 to provide electrical current to product inlet solenoid valve 1921 to open product inlet solenoid valve 1921 at the appropriate times (such as when a pressure sensor in the drying device and pressure sensor 1928 connected to the discharge chute indicate to the computer system 1905 that vacuum pressure equilibrium is established on both sides of the product inlet solenoid valve 1921.

Conversely, the process control application program executing on the computer system 1905 is also configured to transmit suitable control signals to the input/output block 1910 via data communication links 1907 to cause the input/output block 1910 to stop the electrical current from reaching product inlet solenoid valve 1921, and thereby close product inlet solenoid valve 1921 at the appropriate times (such as when other sensors in the system, such as sensor 1941 and 1947 indicate to the computer system 1905 that a specified, desired or sufficient amount of dried pharmaceutical product has flowed into the internal chamber of the discharge chute.

Similarly, a vacuum supply inlet solenoid valve 1926, which fluidly connects the internal chamber of the discharge chute to a vacuum source (not shown in FIG.

19), a gas inlet solenoid valve 1931, which fluidly connects the internal chamber of the discharge chute to a gas source (also not shown), and two product outlet solenoid valves 1956 and 1961 are attached to vacuum inlet 1924, gas inlet 1930, and product outlets 1955 and 1960, respectively, of the discharge chute. All four of these solenoid valves 1926, 1931, 1956 and 1961 are also controlled by electrical current provided by the input/output blocks 1910 and 1915 operating under the control of the process control application program running on the computer system 1905.

As shown in FIG. 19, the automated collection system 1900 may include a plurality of additional solenoid valves 1946, 1956, 1961, 1971 and 1976 attached to various components of the system 1900, and controlled by the computer system 1905 to open and close various channels and passageways in the system. For example, solenoid valves 1946, 1956 and 1961 may be selectively opened and closed by the computer system 1905 and the input/output blocks 1910 and 1915 to control whether solids flowing through the flow diverter assembly 1945 will flow into the primary collection container 1985 via an interconnected product transfer medium 1982, or instead flow into the auxiliary collection container 1990 via another interconnected product transfer medium 1980. And solenoid valves 1971 and 1976 may be selectively opened and closed by the computer system 1905 and the input/output blocks 1910 and 1915 to control, based on pressure measurements supplied by a pressure sensor 1966 attached to the flexible isolator 1965, whether nitrogen will be forced into the flexible isolator 1965 through a nitrogen inlet port 1970 attached to the flexible isolator 1965 and/or allowed to exit the flexible isolator 1965 through a nitrogen exhaust port 1975 attached to the flexible isolator 1965. The automated collection system 1900 may further include a nitrogen supply source (not shown in FIG. 19) configured to provide the nitrogen required for purging a purgeable O-ring smart gasket that could be attached to the mounting plate 1950 of the flow diverter assembly 1945.

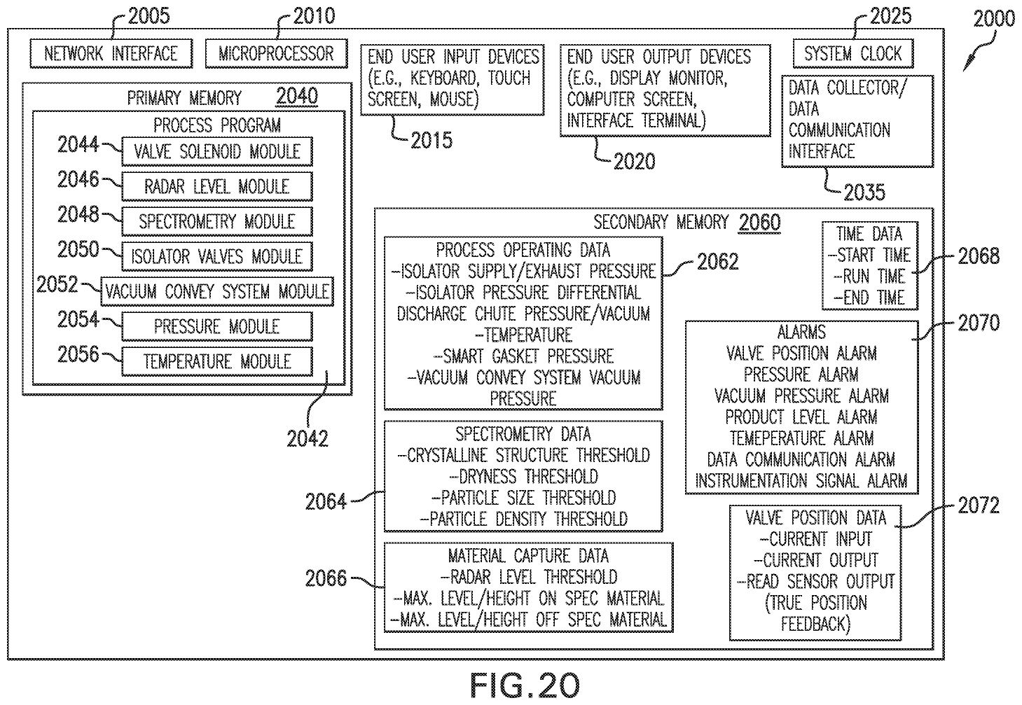

FIGS. 20 shows a high-level block diagram 2000 illustrating by way of example a potential architecture for the computer system 1905 of FIG. 19, which is configured to generate and transmit the control signals used by the input/output boards 1910 and 1915 collect data supplied by the measuring instruments and start and stop the electrical currents that activate and deactivate the solenoid valves according to embodiments of the present invention. As shown in the block diagram of FIG. 20, the computer system 1905 includes a network interface 2005, a microprocessor 2010, a primary memory 2040, a secondary memory 2060, end user input devices 2015, end users output devices 2020, a system clock 2025, and a data collector and communication interface 2035.

The primary memory 2040 stores a process control application program 2042 comprising a plurality of programming modules having program instructions that, when executed by the microprocessor 2010, will cause the microprocessor 2010 to carry out the various functions of the system as described herein, including the functions and processes illustrated in the flow diagrams of FIGS. 18, 21 and 22. These programming modules include a valve solenoid module 2044 for generating control signals for opening and closing the solenoid valves, a radar level module 2046 for receiving, processing and responding to product level measurements supplied by radar level instruments, a spectrometry module 2048 for receiving, processing and responding to one or more spectrometry instruments, an isolator valves module 2050 for opening and closing solenoid valves associated with the flexible isolator 1965, and a vacuum convey system module 2054 for receiving, processing and responding to data associated with the interconnected transfer medium 1980 and 1982 used to move dried pharmaceutical product into the primary and auxiliary collection containers 1985 and 1990. The collection of programming modules also include a pressure module 2054 having program instructions for receiving, processing and responding to pressure measurements supplied by pressure sensors in the system, and a temperature module 2056 having program instructions executable by the microprocessor 2010 for receiving, processing and responding to temperature measurements supplied by temperature sensors in the system.

The secondary memory 2060 may comprise a collection of databases, records, fields, linked lists, arrays, registers or other memory storage objects, which are configured to receive and store various operating parameters, thresholds and settings used by the programming modules of the process control application program 2040 to monitor conditions and control the order and timing the various actions, tasks and processes performed by the system, such as generating and transmitting control signals for opening and closing the solenoid valves in response to incoming instrument measurements. As illustrated in the block diagram of FIG. 20, these data may include, without limitation, process operating data 2062, spectrometry data 2064, material capture data 2066, time data 2068, alarm data 2070 and valve position data 2072.

The computer system 1905 communicates with the input/output blocks 1910 and 1915 via the data collection and communication interface 2035, and may also be configured to communicate with other computers or computer networks via the network interface 2005.

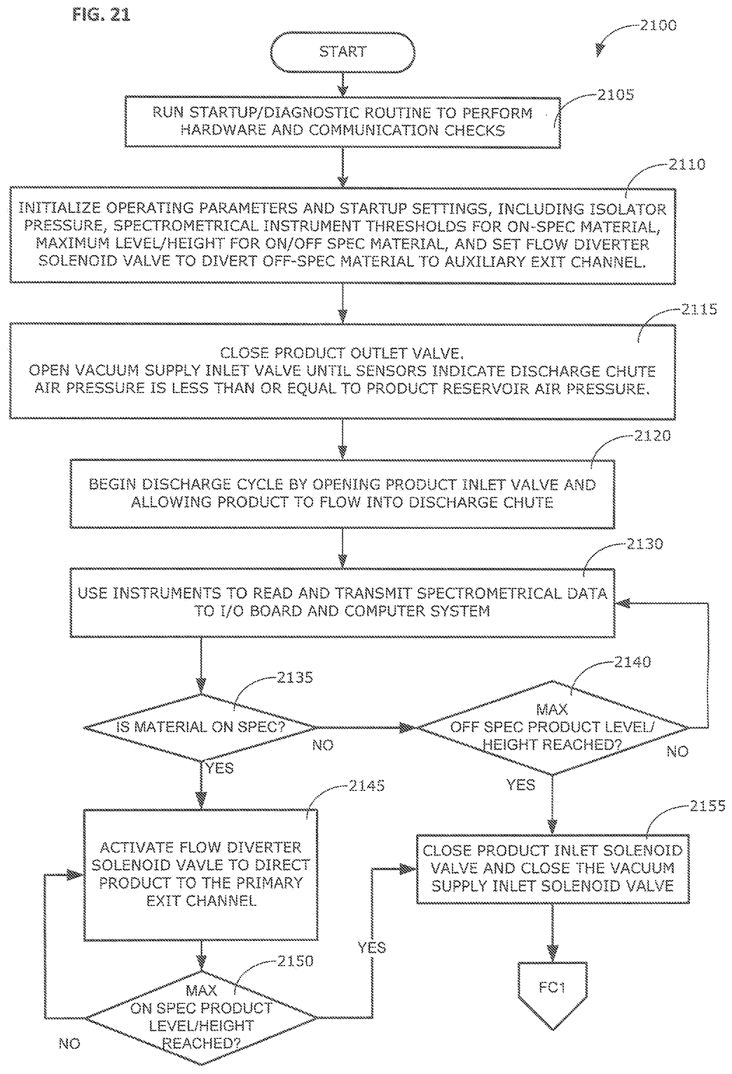

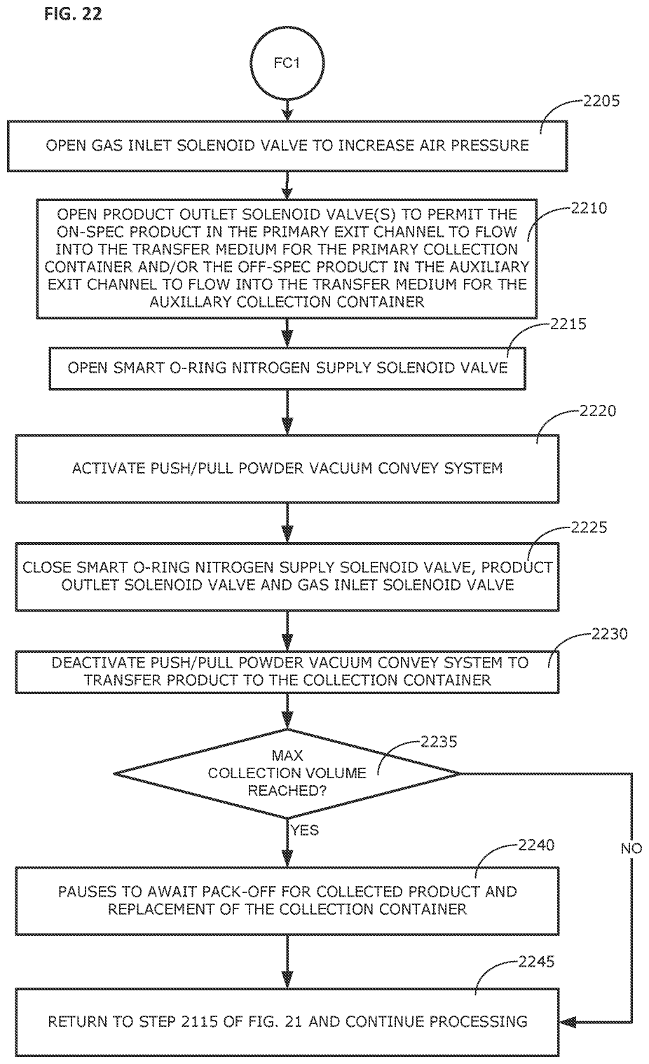

FIGS. 21 and 22 show a high-level flow diagram depicting by way of example the steps of an algorithm executed by the computer system 1905 illustrated by the block diagram of FIG. 21 according to an embodiment of the automated collection system of the present invention. As shown in FIG. 21, the first step (step 2105) is to run a startup and/or diagnostic routine, which may include, for example, performing system checks, valve status checks. instrumentation status checks, data communication checks, electric current or signal tests, alarm and fault checks. Preferably, the process control application program 2042 is configured to automatically address any fault codes or error flags raised during these startup and diagnostic procedures.

Next, at step 2110, process control application program 2042 initializes operating parameters and startup settings, including isolator pressure, spectrometrical instrument thresholds for on-spec material, maximum level/height settings for on/off spec material. Typically, the process control application program 2042 will also generate a control signal to set the flow diverter solenoid valve to divert off-spec material to the auxiliary exit channel in the flow diverter assembly. “On-spec” material is material that has a specified or desired structure, quality, condition or characteristic. “Off-spec” material is material that lacks a specified or desired structure, quality, condition or characteristic. Then the process control application program 2042 closes the outlet valve, opens the vacuum supply inlet valve until sensors indicate that the discharge chute air pressure is less than or equal to the pressure in the product reservoir of the drying device (step 2115). When the pressures are equilibrated, the system next begins the discharge cycle by opening producing the control signals to cause the product inlet valve to open, thereby allowing product to flow from the product reservoir of the drying device and into the discharge chute. See step 2120 in FIG. 21.

While the product is flowing into the discharge chute, the process control application program 2042 receives and monitors instrument measurements, such as spectrometrical data, provided to the computer system 1905 via the input/output boards 1910 and 1915, as shown in step 2130. The program 2042 uses this data to determine, in step 2135, whether the material flowing into the discharge chute is “ON SPEC” (i.e., that it has the specified and required structure, quality and/or other characteristics). If the answer is “YES,” then the program 2042 activates the flow diverter solenoid valve to direct the product to the primary exit channel, and continues filling the primary exit channel until the amount of “ON-SPEC” material collected in the primary exit channel reaches a specified, predetermined or desired level or height (step 2145 in FIG. 21). If the amount of material in the primary exit channel reaches the specified, predetermined or desired height or level, then processing continues at step 2155, wherein the program 2042 closes the product inlet solenoid valve and the vacuum supply solenoid valve.

However, if the answer at step 2135 is “NO,” meaning that the product flowing into the discharge chute is “OFF-SPEC,” then the program 2042 determines whether a specified or predetermined maximum level or height of “OFF-SPEC” material is collected in the auxiliary exit channel (step 2140). If the answer is “NO,” then processing returns to step 2140, where the program 2042 will receive more spectrometrical data measurements. But if the answer in step 2140 is “YES,” meaning the maximum amount of “OFF-SPEC” material has been collected in the auxiliary exit channel, then the program 2042 closes the product inlet solenoid valve and the vacuum supply solenoid valve, as shown in step 2155. Then processing continues at step 2205 by way of flow chart connector FC1 on FIGS. 21 and 22, wherein the program 2042 opens the gas inlet solenoid valve to begin re-pressurizing the discharge chute. Then, as shown in step 2210, the program 2042 opens the product inlet solenoid valve(s) to permit the on-spec product accumulated in the primary exit channel to flow into the transfer medium for the primary collection container, and/or permit the off-spec product accumulated in the auxiliary exit channel to flow into the transfer medium for the auxiliary collection container.

Next, at step 2215, the program 2042 opens the smart O-ring nitrogen supply solenoid valve (step 2215) and activates the push/pull powder vacuum convey system (step 2220). After the product has flowed into the transfer medium(s), the program 2042, at step 2225, closes the smart O-ring nitrogen supply solenoid valve and the product outlet solenoid valve and the gas inlet solenoid valve, and then, at step 2230, deactivates the push/pull powder vacuum convey system to transfer the product from the transfer mediums to the collection containers.

Next, at step 2235, the program 2042 determines whether the maximum collection volume for the collection containers have been reached. If not, then processing returns to step 2115 in FIG. 21, in which the program 2042 closes the outlet valve and opens the vacuum supply inlet valve until sensors indicate that the discharge chute air pressure is less than or equal to the pressure in the product reservoir of the drying device. However, if the answer in step 2235 is “YES,” then program 2042 pauses to await automatic or manual pack off the collected product and replacement of the collection container(s) before returning to step 2115 in FIG. 21.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but it has the full scope defined by the language of the following claims, and equivalents thereof.

1. An apparatus for collecting a pharmaceutical product from a product reservoir of a dryer while the product reservoir of the dryer is under continuous vacuum pressure, the apparatus comprising:
a) a discharge chute comprising
(i) an internal chamber,
(ii) a housing substantially surrounding the internal chamber,
(iii) a product inlet that fluidly connects the internal chamber of the discharge chute to the product reservoir of the dryer,
(iv) a vacuum supply inlet that fluidly connects the internal chamber of the discharge chute to a vacuum source,
(v) a gas inlet that fluidly connects the internal chamber of the discharge chute to a gas source, and
(vi) a product outlet adapted to provide a fluid connection between the internal chamber of the discharge chute and a primary collection container;
b) a vacuum supply control valve that is operable to open or close the vacuum supply inlet on the discharge chute to cause or prevent a suctioning of gas out of the internal chamber of the discharge chute through the vacuum supply inlet by operation of the vacuum source;
c) a product inlet valve that is operable to open or close the product inlet on the discharge chute to cause or prevent a flow of at least a portion of the pharmaceutical product in the product reservoir of the dryer through the product inlet and into the internal chamber of the discharge chute;
d) a gas control valve that is operable to open or close the gas inlet on the discharge chute to cause or prevent a flow of gas into the internal chamber of the discharge chute through the gas inlet by operation of the gas source; and
e) a collection control valve that is operable to open or close the product outlet on the internal chamber of the discharge chute to cause or prevent a flow of at least some of the pharmaceutical product inside of the internal chamber of the discharge chute through the product outlet and into the primary collection container.

2. The apparatus of claim 1, further comprising a flexible isolator, attached to the discharge chute, configured to enclose the fluid connection between the product outlet on the discharge chute and the primary collection container, and thereby substantially isolate the fluid connection between the product outlet and the primary collection container from a surrounding environment.

3-5. (canceled)

6. The apparatus of claim 1, wherein the discharge chute further comprises a flow diverter assembly, the flow diverter assembly comprising:
a) a common channel;
b) a primary exit channel adapted to provide a fluid connection between the common channel and the primary collection container, and configured so that the pharmaceutical product flowing into the primary exit channel from the common channel will flow only into the primary collection container;
c) an auxiliary exit channel, adapted to provide a fluid connection between the common channel and an auxiliary collection container, and configured so that the pharmaceutical product flowing into the auxiliary exit channel from the common channel will flow only into the auxiliary collection container;
d) a flow diverter, located at a nexus between the common channel, the primary exit channel and the auxiliary exit channel, the flow diverter being configured to direct the pharmaceutical product passing through the common channel into the primary exit channel, or into the auxiliary exit channel, or into both the primary exit channel and the auxiliary exit channel, depending on an orientation of the flow diverter; and
e) a flow diverter controller, mechanically connected to the flow diverter, which is operable to control the orientation of the flow diverter.

7. The apparatus of claim 6, further comprising a flexible isolator, attached to the flow diverter assembly, configured to enclose the fluid connection between the primary exit channel and the primary collection container, and thereby substantially isolate the fluid connection between the primary exit channel and the primary collection container from a surrounding environment.

8. The apparatus of claim 7, wherein the flexible isolator attached to the flow diverter assembly is further configured to enclose and surround the fluid connection between the auxiliary exit channel and the auxiliary collection container, and thereby substantially isolate from the surrounding environment both (i) the fluid connection between the primary exit channel of the flow diverter assembly and the primary collection container, and (ii) the fluid connection between the auxiliary exit channel of the flow diverter assembly and the auxiliary collection container.

9. The apparatus of claim 7, further comprising a coupling system for attaching the flexible isolator to the flow diverter assembly.

10. The apparatus of claim 9, wherein the coupling system comprises:
a) a mounting plate on the flow diverter assembly;
b) a groove around a perimeter section of the mounting plate;
c) an opening in a wall of the flexible isolator, the opening having a size and a shape that substantially matches the perimeter section of the mounting plate; and
d) an elastic band attached to a part of the wall of the flexible isolator that is adjacent to the opening;
e) wherein the groove around the perimeter section of the mounting plate is configured to receive and removably hold in place both the elastic band and the part of the wall adjacent to the opening in the flexible isolator to which the elastic band is attached.

11. The apparatus of claim 10, wherein the coupling system further comprises a clamp removably fastened to the perimeter section of the mounting plate so that the elastic band and the part of the wall of the flexible isolator to which the elastic band is attached are sandwiched between an inside wall of the clamp and the groove around the perimeter section of the mounting plate.

12. The apparatus of claim 1, further comprising a discharge monitoring system, attached to the housing of the discharge chute, configured to provide a visual indication of a quantity or a physical state of the pharmaceutical product located inside the internal chamber of the discharge chute.

13. (canceled)

14. The apparatus of claim 1, wherein the dryer comprises a thin-film evaporator, an agitated thin-film evaporator, a wiped film evaporator, a rotary dryer, a spray dryer, a conical dryer, a pressure filter, a fluid bed, or a combination of two or more thereof.

15-17. (canceled)

18. An airlock assembly for collecting solids from a product reservoir of a drying device while the product reservoir remains under continuous vacuum pressure, the airlock assembly comprising:
a) a discharge chute comprising an airtight internal chamber, a housing substantially surrounding the airtight internal chamber, a vacuum supply inlet that fluidly connects the airtight internal chamber of the discharge chute to a vacuum source, a solids inlet that fluidly connects the airtight internal chamber to the product reservoir, a gas inlet that fluidly connects the airtight internal chamber to a gas source, and a solids outlet that fluidly connects the airtight internal chamber to a collection container;
b) a vacuum supply control valve, attached to the vacuum supply inlet, that is operable to open and close the vacuum supply inlet, and thereby permit the vacuum source to suction a sufficient amount of gas from the airtight internal chamber to create inside the airtight internal chamber a pressure level that is less than or substantially equal to a second pressure level inside the product reservoir of the drying device;
c) a product inlet valve, attached to the solids inlet, that is operable to open and close the solids inlet while the pressure level inside the airtight internal chamber of the discharge chute is less than or substantially equal to the second pressure level inside the product reservoir, and thereby cause a gravity-induced flow of at least a portion of the solids from the product reservoir to the airtight internal chamber of the discharge chute through the solids inlet;
d) a gas control valve, attached to the gas inlet, that is operable to open and close the gas inlet to permit the gas source to force gas into the airtight internal chamber of the discharge chute to bring the pressure level inside the airtight internal chamber to an ambient pressure level; and
e) a collection control valve, attached to the solids outlet, that is operable to open and close the solids outlet while the pressure level of the airtight internal chamber is at the ambient pressure level, and thereby permit at least some of the solids inside of the airtight internal chamber of the discharge chute to flow out of the airtight internal chamber and into the collection container via the solids outlet.

19-30. (canceled)

31. An apparatus for isolating and collecting a pharmaceutical product from a product reservoir of a dryer while the product reservoir of the dryer is under continuous vacuum pressure, the apparatus comprising:
a) a discharge chute comprising (i) an internal chamber, (ii) a housing surrounding the internal chamber, (iii) a product inlet solenoid valve that fluidly connects the internal chamber of the discharge chute to the product reservoir of the dryer, (iv) a vacuum supply inlet solenoid valve that fluidly connects the internal chamber of the discharge chute to a vacuum source, (v) a gas inlet solenoid valve that fluidly connects the internal chamber of the discharge chute to a gas source, and (vi) a product outlet solenoid valve that fluidly connects the internal chamber of the discharge chute to a primary collection container;
b) a discharge monitoring system, connected to the discharge chute, configured to detect when a specified quantity of the pharmaceutical product is inside the internal chamber of the discharge chute;
c) a pressure gauge configured to indicate when a measured pressure level inside the internal chamber of the discharge chute is less than or equal to a second measured pressure level existing inside the product reservoir of the dryer;
d) a computer system comprising a microprocessor and a memory for storing program instructions executable by the microprocessor;
e) a vacuum supply control module, stored in the memory and communicatively coupled to the pressure gauge and the vacuum supply inlet solenoid valve, the vacuum supply control module having program instructions that, when executed by the microprocessor, will cause the microprocessor to automatically open the vacuum supply inlet solenoid valve of the discharge chute to permit the vacuum source to remove gases from the internal chamber until the pressure gauge indicates that the measured pressure level inside the internal chamber of the discharge chute is less than or equal to the second measured pressure level existing inside the product reservoir of the dryer;
f) a product inlet module, stored in the memory and communicatively coupled to the discharge monitoring system and the product inlet solenoid valve, the product inlet module having program instructions that, when executed by the microprocessor, will cause the microprocessor to (i) automatically open the product inlet solenoid valve on the discharge chute if the pressure gauge indicates that the measured pressure level inside the internal chamber of the discharge chute is less than or equal to the second measured pressure level existing inside the product reservoir of the dryer, which permits at least a portion of the pharmaceutical product inside the product reservoir to flow through the product inlet solenoid valve and into the internal chamber of the discharge chute, and (ii) automatically close the product inlet solenoid valve on the discharge chute if the discharge monitoring system detects that the specified quantity of the pharmaceutical product is inside the discharge chute;
g) a gas control module, stored in the memory and communicatively coupled to the discharge monitoring system and the gas inlet solenoid valve, the gas control module having program instructions that, when executed by the microprocessor, will cause the microprocessor to automatically open the gas inlet solenoid valve of the discharge chute in response to the product inlet module closing the product inlet solenoid valve, and thereby permit the gas source to admit gas into the internal chamber of the discharge chute through the gas inlet solenoid valve until the pressure gauge indicates that the pressure inside the internal chamber of the discharge chute has reached an ambient pressure level; and
h) a collection control module, stored in the memory and communicatively coupled to the discharge monitoring system and the product outlet solenoid valve, the collection control module having program instructions that, when executed by the microprocessor, will cause the microprocessor to automatically open the product outlet solenoid valve when the discharge monitoring system indicates that the specified quantity of the pharmaceutical product is located in the internal chamber of the discharge chute and the pressure gauge indicates that the measured pressure level inside the internal chamber of the discharge chute is at the ambient pressure level, thereby causing at least some of the pharmaceutical product located inside the internal chamber of the discharge chute to flow out of the internal chamber, through the product outlet solenoid valve and into the primary collection container.

32-43. (canceled)

44. A method of using a discharge chute to collect a pharmaceutical product from a product reservoir of a dryer while the product reservoir of the dryer is under continuous vacuum pressure, the discharge chute comprising (i) an internal chamber, (ii) a housing surrounding the internal chamber, (iii) a product inlet valve that fluidly connects the internal chamber of the discharge chute to the product reservoir of the dryer, (iv) a vacuum supply inlet valve that fluidly connects the internal chamber of the discharge chute to a vacuum source, (v) a gas inlet valve that fluidly connects the internal chamber of the discharge chute to a gas source, and (vi) a product outlet valve that fluidly connects the internal chamber of the discharge chute to a primary collection container, the method comprising the steps of:
a) detecting with a pressure gauge a pressure level inside the internal chamber of the discharge chute;
b) opening the vacuum supply inlet valve of the discharge chute;
c) activating the vacuum source to remove gases from the internal chamber via the vacuum supply inlet valve until the pressure gauge detects that the pressure inside the internal chamber of the discharge chute is less than or equal to the continuous vacuum pressure existing inside the product reservoir of the dryer;
d) opening the product inlet valve on the discharge chute while the pressure gauge indicates that the measured pressure level inside the internal chamber of the discharge chute is less than or equal to the continuous vacuum pressure existing inside the product reservoir of the dryer;
e) causing at least a portion of the pharmaceutical product inside the product reservoir to pass through the product inlet and into the internal chamber of the discharge chute;
f) closing the product inlet valve on the discharge chute;
g) opening the gas inlet valve of the discharge chute;
h) activating the gas source to force gas into the internal chamber of the discharge chute via the gas inlet valve until the pressure gauge indicates that the pressure inside the internal chamber of the discharge chute has reached an ambient pressure level;
i) opening the product outlet valve while the pressure gauge indicates that pressure inside the internal chamber of the discharge chute is at the ambient pressure level; and
j) causing at least some of the pharmaceutical product located inside the internal chamber of the discharge chute to flow out of the internal chamber and through the product outlet valve to collect the pharmaceutical product in the primary collection container.

45. The method of claim 44, further comprising attaching a flexible isolator to the discharge chute to enclose the fluid connection between the product outlet valve on the discharge chute and the primary collection container to substantially isolate the fluid connection between the product outlet valve and the primary collection container from a surrounding environment.

46-48. (canceled)

49. The method of claim 44, further comprising:
a) attaching a flow diverter assembly to the discharge chute and the primary collection container, the flow diverter assembly comprising
(i) a common channel, fluidly connected to the product outlet of the discharge chute, configured to receive the pharmaceutical product as it flows out of the internal chamber of the discharge chute through the product outlet,
(ii) a primary exit channel, fluidly connecting the common channel to the primary collection container, configured so that any pharmaceutical product flowing into the primary exit channel will flow only into the primary collection container,
(iii) an auxiliary exit channel, fluidly connecting the common channel to an auxiliary collection container, configured so that any pharmaceutical product flowing into the auxiliary exit channel will flow only into the auxiliary collection container,
(iv) a flow diverter, located at a nexus between the common channel, the primary exit channel and the auxiliary exit channel, the flow diverter being configured to direct the pharmaceutical product passing through the common channel through the primary exit channel, through the auxiliary exit channel, or through both the primary exit channel and the auxiliary exit channel, depending on an orientation of the flow diverter, and
(v) a flow diverter control; and
b) operating the flow diverter control to change the orientation of the flow diverter, thereby controlling whether the pharmaceutical product flowing out of the internal chamber of the discharge chute and into the flow diverter assembly will pass into primary exit channel of the flow diverter assembly, the auxiliary exit channel of the flow diverter assembly, or both.

5. The method of claim 49, further comprising:
a) monitoring the pharmaceutical product passing into the internal chamber of the discharge chute to determine that the pharmaceutical product meets a specified requirement for the pharmaceutical product; and
b) operating the flow diverter control to change the orientation of the flow diverter to cause the pharmaceutical product flowing out of the internal chamber of the discharge chute and into the flow diverter assembly to pass only into primary exit channel.

51. The method of claim 49, further comprising:
a) monitoring the pharmaceutical product passing into the internal chamber of the discharge chute to determine that the pharmaceutical product does not meet a specified requirement for the pharmaceutical product; and
b) operating the flow diverter control to change the orientation of the flow diverter to cause the pharmaceutical product flowing out of the internal chamber of the discharge chute and into the flow diverter assembly to pass only into auxiliary exit channel.

52. The method of claim 49, further comprising attaching a flexible isolator to the flow diverter assembly to enclose the fluid connection between the primary exit channel of the flow diverter assembly and the primary collection container, and thereby substantially isolating the fluid connection between the primary exit channel and the primary collection container from a surrounding environment.

53. The method of claim 52, further comprising attaching the flexible isolator to the flow diverter assembly to enclose and surround the fluid connection between the auxiliary exit channel of the flow diverter assembly and the auxiliary collection container, and thereby substantially isolate from the surrounding environment both (i) the fluid connection between the primary exit channel of the flow diverter assembly and the primary collection container, and (ii) the fluid connection between the auxiliary exit channel of the flow diverter assembly and the auxiliary collection container.

54. The method of claim 53, further comprising attaching the flexible isolator to the flow diverter assembly using a coupling system, the coupling system comprising:
a) a mounting plate on the flow diverter assembly;
b) a groove around a perimeter section of the mounting plate;
c) an opening in a wall of the flexible isolator, the opening having a size and a shape that substantially matches the perimeter section of the mounting plate; and
d) an elastic band attached to a part of the wall of the flexible isolator that is adjacent to the opening;
e) wherein the groove around the perimeter section of the mounting plate is configured to receive and removably hold in place both the elastic band and the part of the wall adjacent to the opening in the flexible isolator to which the elastic band is attached.

55-59. (canceled)

60. The method of claim 44, further comprising attaching the discharge chute to the product reservoir of the dryer.
